(19) United States
(12) Patent Application Publication
(10) Pub. No.: US 2016/0118156 A1
(43) Pub. Date: Apr. 28, 2016

(54) METAL NANOWIRE-CONTAINING COMPOSITION

(71) Applicant: SEIKO PMC CORPORATION, Tokyo (JP)

(72) Inventors: Tomoaki KAWAGUCHI, Ichihara-shi (JP); Toshiyuki HASEGAWA, Ichihara-shi (JP); Munetoshi KURIMURA, Ichihara-shi (JP)

(73) Assignee: SEIKO PMC CORPORATION, Chuo-ku, Tokyo (JP)

(21) Appl. No.: 14/896,153

(22) PCT Filed: May 21, 2014
(86) PCT No.: PCT/JP2014/063415

§ 371 Date: Dec. 4, 2015

(30) Foreign Application Priority Data
Jun. 7, 2013 (JP) 2013-120552

(51) Int. Cl. H01B 1/22

(52) U.S. Cl. CPC H01B 1/22

(57) ABSTRACT

The present invention provides a metal nanowire-containing composition that has high compatibility between high preservation stability and coating suitability and that can produce a coating film having high compatibility among high conductivity, high transparency, and low turbidity and high compatibility among high abrasion resistance, water resistance, alcohol resistance, and adhesiveness to a substrate. The metal nanowire-containing composition contains a metal nanowire, a binder, a surfactant, and a solvent, wherein the binder contains a binder component (A) being a polysaccharide; and a binder component (B) being at least one selected from aqueous polyester resins, aqueous polyurethane resins, aqueous acrylic resins, and aqueous epoxy resins.

### TECHNICAL FIELD

The present invention relates to a metal nanowire-containing composition containing a metal nanowire, a binder, a surfactant, and a solvent, wherein the binder contains a binder component (A) being a polysaccharide; and a binder component (B) being at least one selected from aqueous polyester resins, aqueous polyurethane resins, aqueous acrylic resins, and aqueous epoxy resins.

### BACKGROUND ART

In recent years, for example, displays, such as liquid crystal displays, plasma displays, organic electroluminescent displays, and electronic paper; input sensors, such as touch panels; and solar cells utilizing sunlight, such as thin-film amorphous Si solar cells and dye-sensitized solar cells, have been increasingly used, and demands for transparent conductive films, which are essential for these devices, have been increasing.

Metal nanowires have nanoscale diameters and thereby have high transmissivity in the visible light region and are expected as transparent conductive films replacing for indium tin oxide (ITO). Transparent conductive films composed of metal nanowires having particularly high conductivity and stability have been proposed (see, for example, Patent Documents 1 to 3).

A transparent conductive film composed of metal nanowires is generally produced by a method of forming a film through application of a metal nanowire-containing composition. The metal nanowire-containing composition is at least composed of metal nanowires and a dispersion medium or binder. Since the metal nanowires have a specific gravity higher than that of the dispersion medium or binder, the metal nanowires very easily precipitate in the metal nanowire-containing composition, complicating preparation of a metal nanowire-containing composition stable for a long time. In addition, the precipitated and accumulated metal nanowires are tend to decrease redispersibility due to temporal fusion bonding therebetween, and a strong stirring required for redispersion may damage the metal nanowires to reduce the average major-axis length and thereby may reduce the characteristics essential for metal nanowires. Metal nanowire-containing compositions having high preservation stability are essential for production of high-quality transparent conductive films.

As described-above, since liquid crystal displays or input sensors, such as touch panels, include transparent conductive films,
metal nanowire-containing compositions are required to have high coating suitability; and
the coating films of the metal nanowire-containing compositions are required to have high conductivity, high transparency, and low turbidity.

In addition, in order to prevent deterioration of the properties of the transparent conductive films during the process of incorporation into electronic devices, such as those mentioned above, high water resistance, abrasion resistance, alcohol resistance, and adhesiveness to a substrate are required.

Accordingly, the high preservation stability and coating suitability of the metal nanowire-containing compositions to be used for forming transparent conductive films should be compatible at high levels with
the high conductivity, high transparency, low turbidity; high abrasion resistance, high water resistance, and high alcohol resistance, and high adhesiveness to the substrate of the coating films made of the metal nanowire-containing composition.

Patent Document 2 discloses binders, such as polyester resins, polyurethane resins, acrylic resins, and epoxy resins. These resins have low affinity to metal nanowires, and metal nanowires are readily fusion-bonded mutually in a metal nanowire composition. Accordingly, it is believed that the metal nanowire-containing composition has low preservation stability and coating suitability, and the coating film of the metal nanowire-containing composition has low conductivity and transparency and high turbidity. Alternatively, the metal nanowire-containing composition described in Patent Document 3 contains a polysaccharide binder. Since polysaccharides are readily dissolved in water or alcohol because of their structures, the coating film of the metal nanowire-containing composition shows low adhesiveness to a substrate and has low abrasion resistance, water resistance, and alcohol resistance.

### RELATED ART

### Patent Document

Patent Document 1: Japanese Patent Application Laid-Open No. 9-324324
Patent Document 2: Japanese Patent Application Laid-Open No. 2005-317395
Patent Document 3: U.S. Patent Application Publication No. 2007/0074316

### SUMMARY OF INVENTION

The present invention provides
a metal nanowire-containing composition having high preservation stability and coating suitability;
a coating film made of the metal nanowire-containing composition having high conductivity, high transparency, low turbidity; high abrasion resistance, high water resistance, high alcohol resistance, and high adhesiveness to a substrate;
where these properties of the metal nanowire-containing composition are compatible at high levels with these properties of the coating film.

### Solution to Problem

The present inventors, who have diligently studied in order to solve the above-mentioned problems, have found that
a metal nanowire-containing composition containing a binder including a binder component (A) being a polysaccharide and a binder component (B) being at least one selected from aqueous polyester resins, aqueous polyurethane resins, aqueous acrylic resins, and aqueous epoxy resins has high preservation stability and coating suitability;
a coating films made of the metal nanowire-containing composition has high conductivity, high transparency, low turbidity; high abrasion resistance, water resistance, alcohol resistance, and adhesiveness to a substrate; and
that these properties of the metal nanowire-containing composition are compatible at high levels with these properties of the coating film. Accordingly, the inventors have accomplished the present invention.

That is, the present invention relates to the following aspects:

(1) A metal nanowire-containing composition comprising a metal nanowire, a binder, a surfactant, and a solvent, wherein the binder comprises the following binder components (A) and (B):
binder component (A): a polysaccharide, and
binder component (B): at least one selected from aqueous polyester resins, aqueous polyurethane resins, aqueous acrylic resins, and aqueous epoxy resins;

(2) The metal nanowire-containing composition according to aspect (1), wherein the binder component (B) is an aqueous polyester resin;

(3) The metal nanowire-containing composition according to aspect (1) or (2), wherein the binder component (A) is at least one selected from hydroxypropyl guar gum and derivatives thereof, hydroxypropyl methyl cellulose and derivatives thereof, and methyl cellulose and derivatives thereof;

(4) The metal nanowire-containing composition according to any one of aspects (1) to (3), wherein the binder component (A) is a polysaccharide derivative prepared by graft polymerization of a (meth)acrylate ester;

(5) The metal nanowire-containing composition according to any one of aspects (1) to (4), wherein the metal nanowire is contained in an amount of at most 10 parts by mass relative to 100 parts by mass of the total amount of the metal nanowire-containing composition, the binder is contained in an amount of 10 to 400 parts by mass relative to 100 parts by mass of the metal nanowire, and the surfactant is contained in an amount of 0.05 to 10 parts by mass relative to 100 parts by mass of the metal nanowire;

(6) The metal nanowire-containing composition according to any one of aspects (1) to (5), wherein the mass ratio of the binder component (A) to the binder component (B) is 25:75 to 75:25;

(7) The metal nanowire-containing composition according to any one of aspects (1) to (6), wherein the binder component (B) is an aqueous polyester resin prepared by graft polymerization of a (meth)acrylate ester;

(8) The metal nanowire-containing composition according to any one of aspects (1) to (7), further comprising a silane coupling agent;

(9) The metal nanowire-containing composition according to any one of aspects (1) to (7), further comprising a polyisocyanate compound;

(10) The metal nanowire-containing composition according to any one of aspects (1) to (7), further comprising at least one of a photoinitiator and a thermal polymerization initiator as well as at least one of a polymerizable monomer and a macromonomer;

(11) The metal nanowire-containing composition according to any one of aspects (1) to (10), wherein the composition is for a transparent conductive film;

(12) The metal nanowire-containing composition according to any one of aspects (1) to (7), further comprising an alkaline thickener or a urethane thickener;

(13) The metal nanowire-containing composition according to any one of aspects (1) to (12), wherein the metal nanowire is a silver nanowire;

(14) The metal nanowire-containing composition according to aspect (13), wherein the silver nanowire is produced by a method comprising a step of reacting a silver compound in a polyol at 25° C. to 180° C. in the presence of a wire integration regulator being an N-substituted acrylamide-containing polymer;

(15) A metal nanowire-containing film formed with the metal nanowire-containing composition according to any one of aspects (1) to (14); and

(16) A transparent conductor comprising a substrate and the metal nanowire-containing film according to aspect (15) disposed on the substrate.

The term “(meth)acryl” refers to “acryl and methacryl”, and the abbreviation may be similarly used hereinafter.

### Effects of Invention

The present invention can provide a metal nanowire-containing composition having high preservation stability and coating suitability and a coating films made of the metal nanowire-containing composition having high conductivity, high transparency, low turbidity, high abrasion resistance, high water resistance, high alcohol resistance, and adhesiveness to a substrate, where these properties of the metal nanowire-containing composition are compatible at high levels with these properties of the coating film.

### DESCRIPTION OF EMBODIMENT

The present invention will now be described in detail.

### [Metal Nanowire-Containing Composition]

The metal nanowire-containing composition according to the present invention contains a metal nanowire, a binder, a surfactant, and a solvent. The binder contains a binder component (A) being a polysaccharide and a binder component (B) being at least one selected from aqueous polyester resins, aqueous polyurethane resins, aqueous acrylic resins, and aqueous epoxy resins. The composition may further contain other optional components. Examples of the metal in the metal nanowire of the present invention include gold, silver, copper, nickel, platinum, palladium, cobalt, tin, and lead. In addition, alloys and metal compounds of these metals and products prepared by plating these metals can also be used as the metal nanowire of the present invention. Examples of the metal compounds include metal oxides, and examples of the plated metals include gold-plated silver. Among these metals, silver is more preferred. A case of using a silver nanowire will now be described as a typical example of the metal nanowire of the present invention. In the use of any other metal nanowire, the term “silver nanowire” in the following description should be read as “metal nanowire”.

### [Silver Nanowire]

The “silver nanowire” in the present invention is a wire-shaped silver structure having a nanoscale cross-sectional diameter of less than 1 μm and having an aspect ratio (major-axis length/diameter) of 10 or more.

The “silver nanowire dispersion” in the present invention is composed of a silver nanowire and a solvent.

The silver nanowire preferably has a diameter of 5 nm or more and less than 250 nm and more preferably 10 nm or more and less than 150 nm. In the case that the composition of the present invention is used for a transparent conductive film, the silver nanowire advantageously has a diameter of less than 250 nm in order to reduce the light diffusion by the silver nanowire, to increase the transparency of the film, and to reduce the turbidity of the film. In order to enhance the conductivity of the silver nanowire and to improve the durability of the film, a diameter of 5 nm or more is advantageous and preferred.

The silver nanowire preferably has a major-axis length of 0.5 μm or more and 500 μm or less and more preferably 2.5 μm or more and 100 μm or less. In the case that the composition of the present invention is used for a transparent conductive film, the silver nanowire advantageously has a major-axis length of 0.5 μm or more, in order to express the conductivity by formation of a three-dimensional conductive network structure through mutual contact and broad spatial distribution of the silver nanowires. Furthermore, in order to prevent entanglement of the silver nanowires and to improve the preservation stability of the silver nanowires, a major-axis length of 500 μm or less is advantageous and preferred.

The silver nanowires may be produced by any known process. In the present invention, a method including a step of reacting a silver compound in a polyol at 25° C. to 180° C. in the presence of an N-substituted acrylamide-containing polymer serving as a wire integration regulator is particularly preferred, from the viewpoint of dispersibility of the silver nanowires in a silver nanowire-containing composition and the conductivity, transparency, and turbidity of the coating film formed with the silver nanowire-containing composition.

The content of the silver nanowire in the silver nanowire-containing composition is preferably 0.01% by mass or more and 30% by mass or less, more preferably 0.05% by mass or more and 10% by mass or less, and most preferably 0.1% by mass or more and 2% by mass or less, relative to the total mass of the silver nanowire composition. In order to prevent entanglement of the silver nanowires and to improve the preservation stability of the silver nanowires, a content of the silver nanowires of 30% by mass or less is advantageous and preferred. At a low content of the silver nanowire, the conductivity is provided to the coating film of the silver nanowire composition by multiple coating steps, but a content of 0.01% by mass or more is advantageous and preferred from the viewpoint of productivity.

### [Binder]

The silver nanowire-containing composition of the present invention contains a binder composed of a binder component (A) being a polysaccharide and a binder component (B) being at least one selected from aqueous polyester resins, aqueous polyurethane resins, aqueous acrylic resins, and aqueous epoxy resins. In addition, the silver nanowire-containing composition of the present invention may contain another appropriate binder component, in addition to the binder components (A) and (B), within a range that can maintain the required characteristics of the composition

In the present invention, the use of the binder including the binder components (A) and (B) can improve the preservation stability and coating suitability of the silver nanowire-containing composition, the adhesiveness of the coating film formed with the silver nanowire-containing composition to a substrate, and the abrasion resistance, water resistance, and alcohol resistance of the film, to the maximum extent possible.

### [Polysaccharide]

In the present invention, the term “(A) polysaccharide” refers to a polysaccharide or its derivative. Examples of the polysaccharide include starch, pullulan, guar gum, cellulose, chitosan, locust bean gum, and enzymatic decomposition products thereof. Examples of the derivatives of the polysaccharide include partially etherified polysaccharide derivatives prepared by introducing, to a polysaccharide, at least one selected from alkyl groups (e.g., methyl, ethyl, and propyl), hydroxyalkyl groups (e.g., hydroxyethyl, hydroxypropyl, and hydroxybutyl), carboxyalkyl groups (e.g., carboxymethyl and carboxyethyl), and metal salts thereof; and polysaccharide derivatives and partially etherified polysaccharide derivatives prepared by graft polymerization of a (meth)acrylate ester to a polysaccharide or a partially etherified polysaccharide. Among these polysaccharides, preferred are hydroxypropyl guar gum and its derivatives (hydroxypropyl guar gums), hydroxypropyl methyl cellulose and its derivatives (hydroxypropyl methyl celluloses), methyl cellulose and its derivatives (methyl celluloses), sodium salts of carboxymethyl cellulose, methyl cellulose, hydroxypropyl cellulose, hydroxypropyl methyl cellulose, hydroxyethyl cellulose, ethyl cellulose, guar gum, hydroxyethyl guar gum, hydroxypropyl guar gum, and products prepared by graft polymerization of a (meth)acrylate ester to these polysaccharides. More preferred are methyl cellulose, hydroxypropyl methyl cellulose, hydroxypropyl guar gum, and products prepared by graft polymerization of a (meth)acrylate ester to these polysaccharides. Most preferred are products prepared by graft polymerization of a (meth)acrylate ester to methyl cellulose, hydroxypropyl methyl cellulose, and hydroxypropyl guar gum. These polysaccharides may be used alone or in combination.

The polysaccharides prepared by graft polymerization of a (meth)acrylate ester can be produced by a known process. In the present invention, examples of the graft polymerization include polymerization of a (meth)acrylate ester in the presence of a polymerizable unsaturated group-containing polysaccharide or a partially etherified polysaccharide. The polymerizable unsaturated groups can be introduced into the polysaccharide by a known process. In the present invention, from the viewpoint of the transparency and turbidity of the film, polymerizable unsaturated groups are preferably introduced into a polysaccharide by a method of adding an organic carboxylic anhydride having a polymerizable unsaturated group to a polysaccharide; a method of adding an organic carboxylic anhydride, such as phthalic anhydride, to a polysaccharide to introduce the carboxyl group to the polysaccharide and then adding a glycidyl group-containing compound having a polymerizable unsaturated group thereto; a method of adding an alkoxysilyl group-containing compound having a polymerizable unsaturated group to a polysaccharide; a method of adding an isocyanate group-containing compound having a polymerizable unsaturated group to a polysaccharide; or a method of adding a methylol group-containing compound having a polymerizable unsaturated group to a polysaccharide. Examples of the organic carboxylic anhydride having a polymerizable unsaturated group include (meth)acrylic anhydride, maleic anhydride, and itaconic anhydride. Examples of the glycidyl group-containing compound having a polymerizable unsaturated group include glycidyl(meth)acrylate. Examples of the alkoxysilyl group-containing compound having a polymerizable unsaturated group include 3-(trimethoxysilyl)propyl methacrylate. Examples of the isocyanate group-containing compound having a polymerizable unsaturated group include 2-isocyanatoethyl(meth)acrylate. Examples of the methylol group-containing compound having a polymerizable unsaturated group include N-methylol(meth)acrylamide.

The (meth)acrylate ester used in the graft polymerization to a polysaccharide may be any ester of (meth)acrylic acid. Examples of such esters include methyl(meth)acrylate, ethyl(meth)acrylate, n-butyl(meth)acrylate, isobutyl(meth)acrylate, 2-ethylhexyl(meth)acrylate, isoamyl(meth)acrylate, isooctyl(meth)acrylate, lauryl(meth)acrylate, isomyristyl(meth)acrylate, stearyl(meth)acrylate, cyclohexyl(meth)acrylate, isobonyl(meth)acrylate, phenoxyethyl(meth)acrylate, dimethylaminoethyl(meth)acrylate, diethylaminoethyl(meth)acrylate, and 2-hydroxyethyl(meth)acrylate. In the present invention, preferred are methyl(meth)acrylate, ethyl(meth)acrylate, n-butyl(meth)acrylate, 2-ethylhexyl(meth)acrylate, and 2-hydroxyethyl(meth)acrylate, from the viewpoint of the coating suitability of the silver nanowire composition and the transparency and turbidity of the film. These (meth)acrylate esters may be used alone or in combination.

Instead of the (meth)acrylate ester for the graft polymerization to a polysaccharide, a polysaccharide derivative of another polymerizable monomer can also be used within a range that exhibits the advantageous effects of the present invention. Examples of such a polymerizable monomer include (meth)allyl compounds, such as (meth)allyl alcohol and glycerol mono(meth)allyl ether; aromatic vinyls, such as styrene; carboxylic acid vinyl esters, such as vinyl acetate; (meth)acrylamides, such as (meth)acrylamide, N-methyl(meth)acrylamide, and N-(2-hydroxyethyl)(meth)acrylamide; and unsaturated carboxylic acids, such as (meth)acrylic acid, maleic acid, fumaric acid, and itaconic acid. These monomers may be used alone or in combination.

The polysaccharide prepared by graft polymerization of a (meth)acrylate ester used in a preferred embodiment of the present invention has a hydrophobic site and hydrophilic site in one molecule due to the graft polymerization of the (meth)acrylate ester and enhances the affinity to silver nanowires and also enhances the affinity to the binder component (B). The polysaccharide improves the dispersion of the silver nanowires in the silver nanowire-containing composition, and thus improves the conductivity, transparency, turbidity, and abrasion resistance of the coating film formed with the silver nanowire-containing composition and the adhesiveness between the film and a substrate.

The polysaccharide has high affinity to silver nanowires and increases the viscosity of the composition to improve the dispersion of the silver nanowires in the silver nanowire-containing composition, which probably contributes to the high preservation stability and coating suitability of the silver nanowire-containing composition and the high transparency and conductivity and the low turbidity of the coating film formed with the silver nanowire-containing composition.

The other component, i.e., the binder component (B), of the binder in the present invention is at least one selected from aqueous polyester resins, aqueous polyurethane resins, aqueous acrylic resins, and aqueous epoxy resins.

### [Aqueous Polyester Resin]

The aqueous polyester resin may be any aqueous polyester resin. Examples of such aqueous polyester resins include polycondensates of multivalent carboxylic acids or ester-forming derivatives thereof and polyols or ester-forming derivatives thereof. The term “aqueous polyester resin” encompasses derivatives from the aqueous polyester resin. Examples of the derivatives of the aqueous polyester resin include (meth)acryl-modified aqueous polyester resins prepared by graft polymerization of (meth)acrylate esters to aqueous polyesters. Graft polymerization of a (meth)acrylate ester to an aqueous polyester resin enhances the water resistance and the alcohol resistance compared to those of the aqueous polyester resin itself. A combination of the aqueous polyester resin graft-polymerized with a (meth)acrylate ester and a polysaccharide graft-polymerized with a (meth)acrylate ester preferably enhances the coating suitability of the silver nanowire-containing composition and the water resistance and alcohol resistance of the coating film formed with the silver nanowire-containing composition. The aqueous polyester resin graft-polymerized with a (meth)acrylate ester as a preferable embodiment of the aqueous polyester resin can be prepared by known graft polymerization of a (meth)acrylate ester to an aqueous polyester resin, as in the above-described graft polymerization of a (meth)acrylate ester to a polysaccharide.

The multivalent carboxylic acid may be any compound having two or more carboxylic acid groups. Examples of such multivalent carboxylic acids include aromatic dicarboxylic acids, such as phthalic acid, terephthalic acid, isophthalic acid, naphthalic acid, 1,2-naphthalenedicarboxylic acid, 1,4-naphthalenedicarboxylic acid, 1,5-naphthalenedicarboxylic acid, 2,6-naphthalenedicarboxylic acid, biphenyldicarboxylic acid, and orthophthalic acid; aliphatic dicarboxylic acids, such as linear, branched, or alicyclic oxalic acid, malonic acid, succinic acid, glutaric acid, adipic acid, pimelic acid, 2,2-dimethylgultaric acid, suberic acid, azelaic acid, sebacic acid, dodecanedicarboxylic acid, 1,3-cyclopentanedicarboxylic acid, 1,4-cyclohexanedicarboxylic acid, and diglycolic acid; tricarboxylic acids, such as trimellitic acid, trimesic acid, and pyromellitic acid; and metal sulfonate group-containing dicarboxylic acids, such as sulfoterephthalic acid, 5-sulfoisophthalic acid, 4-sulfoisophthalic acid, 2-sulfoisophthalic acid, and 4-sulfonaphthalene-2,7-dicarboxylic acid, and alkali metal salts thereof. Examples of the ester-forming derivatives of the multivalent carboxylic acids include anhydrides, esters, acid chlorides, and halides of the multivalent carboxylic acids. These compounds may be used alone or in combination.

The polyol may be any compound having two or more hydroxyl groups. Examples of such polyols include ethylene glycol; diethylene glycol; trimethylolpropane; glycerin; polyethylene glycols, such as triethylene glycol, tetraethylene glycol, pentaethylene glycol, hexaethylene glycol, heptaethylene glycol, and octaethylene glycol; polypropylene glycols, such as propylene glycol, dipropylene glycol, tripropylene glycol, and tetrapropylene glycol; 1,3-propanediol; 1,3-butanediol; 1,4-butanediol; 1,5-pentadiol; 1,6-hexanediol; 2,2-dimethyl-1,3-propanediol; 2-ethyl-2-butyl-1,3-propanediol; 2-ethyl-2-isobutyl-1,3-propanediol; 2,2,4-trimethyl-1,6-hexanediol; 1,2-cyclohexanedimethanol; 1,3-cyclohexanedimethanol; 1,4-cyclohexanedimethanol; and 2,2,4,4-tetramethyl-1,3-cyclobutanediol. Examples of the ester-forming derivatives of the polyol include derivatives prepared by acetification of the hydroxyl groups of polyols. These polyols may be used alone or in combination.

### [Aqueous Polyurethane Resin]

The aqueous polyurethane resin may be any polyurethane resin that can be dissolved or dispersed in an aqueous solvent or aqueous dispersion medium. Examples of the aqueous polyurethane resin include those prepared by polyaddition reactions of diisocyanates and polyols, followed by neutralization, chain extension, and aqueous modification. Examples of the diisocyanate include aliphatic diisocyanates, such as tetramethylene diisocyanate; alicyclic diisocyanates, such as isophorone diisocyanate; and aromatic diisocyanates, such as 2,4-tolylene diisocyanate. Examples of the polyol include poly(ethylene glycols), such as ethylene glycol and di(ethylene glycol); poly(propylene glycols), such as propylene glycol; low-molecular-weight glycols, such as 1,3-propanediol, 1,3-butanediol, 2-butyl-2-ethyl-1,3-propanediol, hydrogenated bisphenol A, and ethylene oxide adduct of bisphenol A; polyethers, such as poly(ethylene glycols) and poly(propylene glycols); condensation polyesters of ethylene glycol and adipic acid; polyhydroxycarboxylic acids, such as 2,2-dimethylolpropionic acid; and polycaprolactone. Examples of the neutralizing agent include inorganic acids, such as hydrochloric acid; organic acids, such as acetic acid and lactic acid; amines, such as trimethylamine, triethylamine, and triethanolamine; sodium hydroxide; potassium hydroxide; and ammonia. Examples of the chain-elongating agent include polyols, such as ethylene glycol and propylene glycol; diamines, such as ethylene diamine, propylene diamine, piperazine, isophorone diamine, and methyldiethanolamine; and water.

### [Aqueous Acrylic Resin]

The aqueous acrylic resin may be any acrylic resin that can be dissolved or dispersed in an aqueous solvent or aqueous dispersion medium. Examples of the aqueous acrylic resin include anionic aqueous acrylic resins that are copolymers of (meth)acrylate esters and anionic polymerizable monomers; and cationic aqueous acrylic resins that are copolymers of (meth)acrylate esters and cationic polymerizable monomers. The anionic groups of the anionic aqueous acrylic resin may be partially or fully neutralized with an alkali metal, such as potassium or sodium; an alkali earth metal; ammonia; or an amine compound, such as methylamine, ethylamine, dimethylamine, diethylamine, trimethylamine, or triethylamine. The cationic groups of the cationic aqueous acrylic resin may be partially or fully neutralized with an inorganic acid, such as hydrochloric acid or phosphoric acid; or an organic acid, such as acetic acid, lactic acid, or phosphonic acid. Examples of the (meth)acrylate ester include methyl(meth)acrylate, ethyl(meth)acrylate, n-butyl(meth)acrylate, isobutyl(meth)acrylate, 2-ethylhexyl(meth)acrylate, isoamyl(meth)acrylate, isooctyl(meth)acrylate, lauryl(meth)acrylate, isomyristyl(meth)acrylate, stearyl(meth)acrylate, cyclohexyl(meth)acrylate, isobonyl(meth)acrylate, phenoxyethyl(meth)acrylate, dimethylaminoethyl(meth)acrylate, diethylaminoethyl(meth)acrylate, and 2-hydroxyethyl(meth)acrylate. These (meth)acrylate esters may be used alone or in combination. Examples of the anionic polymerizable monomer that can be used for the anionic aqueous acrylic resin include unsaturated monocarboxylic acids, such as (meth)acrylic acid and crotonic acid; unsaturated dicarboxylic acids, such as maleic acid, maleic anhydride, fumaric acid, itaconic acid, itaconic anhydride, citraconic acid, and citraconic anhydride; unsaturated sulfonic acids, such as vinylsulfonic acid, styrenesulfonic acid, (meth)allyl sulfonic acid, and 2-acrylamido-2-methylpropanesulfonic acid; and unsaturated phosphonic acids, such as vinylphosphonic acid and α-phenylphosphonic acid. Examples of the cationic polymerizable monomer that can be used for the cationic aqueous acrylic resin include N,N-dialkylamino(hydroxy)alkyl(meth)acrylates, such as N,N-dimethylaminomethyl(meth)acrylate and N,N-dimethylaminoethyl(meth)acrylate; N,N-dialkylamino(hydroxy)alkyl(meth)acrylamides, such as N,N-dimethylaminomethyl(meth)acrylamide and N,N-dimethylaminoethyl(meth)acrylamide; and allylamines, diallylamines, and salts and quaternary products thereof.

The aqueous acrylic resin of the present invention may contain any other optional polymerizable monomer, in addition to the above-mentioned (meth)acrylate esters and anionic or cationic polymerizable monomers. Examples of such optional polymerizable monomer include (meth)allyl compounds, such as (meth)allyl alcohol and glycerol mono(meth)allyl ether; aromatic vinyls, such as styrene; carboxylic acid vinyl esters, such as vinyl acetate; and (meth)acrylamides, such as (meth)acrylamide, N-methyl(meth)acrylamide, and N-(2-hydroxyethyl)(meth)acrylamide. These monomers may be used alone or in combination.

### [Aqueous Epoxy Resin]

The aqueous epoxy resin may be any epoxy resin that can be dissolved or dispersed in an aqueous solvent or aqueous dispersion medium, may be any aqueous epoxy resin prepared by a known method, or may be any commercially available aqueous epoxy resin. Examples of the aqueous epoxy resin include those prepared by reacting an amine compound with epoxy groups of a raw material resin selected from a) a bisphenol epoxy oligomer; b) a modified epoxy resin prepared by reacting a bisphenol epoxy oligomer to any one of fatty acids and derivatives thereof, fatty acid amides, and unsaturated group-containing amines; and c) a modified epoxy resin prepared by reacting bisphenol A to a mixture of a bisphenol epoxy oligomer and a polyalkylene glycol diglycidyl ether; and partially neutralizing the amino groups introduced into the raw material resin with an acid to make the epoxy resin soluble or dispersible in water. Other examples of the aqueous epoxy resin include those prepared by polymerizing an anionic monomer in the presence of any of the above-mentioned raw material resins a) to c), and partially or completely neutralizing the anionic groups with an alkali metal, such as potassium or sodium; or an amine compound, such as ammonia, methylamine, ethylamine, dimethylamine, dimethylamine, trimethylamine, or triethylamine, to make the epoxy resin soluble or dispersible in water. Other examples of the aqueous epoxy resin include those prepared by polymerizing a cationic polymerizable monomer in the presence of any of the above-mentioned raw material resins a) to c), and partially or completely neutralizing the cationic groups with an inorganic acid, such as hydrochloric acid or phosphoric acid; or an organic acid, such as acetic acid or lactic acid, to make the epoxy resin soluble or dispersible in water.

It is believed that these aqueous polyester resins, aqueous polyurethane resins, aqueous acrylic resins, and aqueous epoxy resins have high affinity to a substrate and increase the adhesiveness between the coating film formed with the silver nanowire-containing composition and a substrate.

The binder component (B) has high compatibility to polysaccharides, and the use of the binder composed of the binder component (A) and the binder component (B) can achieves high affinity to both silver nanowires and a substrate. In the coating of the silver nanowire-containing composition onto a substrate, the solvent probably evaporates, while maintaining the good dispersion of the silver nanowires even on the substrate, to form a film containing uniformly dispersed silver nanowires. As a result, the combined use of the binder component (A) and the binder component (B) allows the metal nanowire-containing composition to form a coating film having further enhanced transparency and conductivity and reduced turbidity, compared to the sole use of the binder component (A) only. In addition, the combined use enhances the abrasion resistance, water resistance, and alcohol resistance of the resulting film, compared to the sole use of the binder component (B) only. Among the above-mentioned examples of the binder component (B), aqueous polyester resins are preferred from the viewpoint of the adhesiveness between the coating film formed with the silver nanowire-containing composition and a substrate and the water resistance and alcohol resistance of the film.

In the present invention, the content of the binder in the silver nanowire-containing composition is preferably 1% by mass or more and 800% by mass or less, more preferably 10% by mass or more and 400% by mass or less, and most preferably 100% by mass or more and 200% by mass or less relative to the amount of the silver nanowires. The content of the binder is advantageously 1% by mass or more relative to the amount of the silver nanowires from the viewpoint of the preservation stability and coating suitability of the silver nanowire composition, the conductivity, transparency, turbidity, abrasion resistance, water resistance, and alcohol resistance of the coating film formed with the silver nanowire composition and the adhesiveness between the film and a substrate. Furthermore, the content is advantageously 10% by mass or more from the viewpoint of the conductivity and abrasion resistance of the coating film formed with the silver nanowire composition and the adhesiveness between the film and a substrate, but the viewpoint of the conductivity of the film, the content is advantageously 800% by mass or less.

In the present invention, the mass ratio of the binder component (A) to the binder component (B) in the silver nanowire-containing composition is preferably 10:90 to 99:1, more preferably 25:75 to 75:25, and most preferably 35:65 to 65:35. Since the high preservation stability and coating suitability of the silver nanowire-containing composition are compatible at high levels with the high conductivity, high transparency, low turbidity, high abrasion resistance, high water resistance, high alcohol resistance, and high adhesiveness to a substrate of a coating film made of the metal nanowire-containing composition, the mass ratio of the binder component (A) to the binder component (B) in the silver nanowire-containing composition is advantageously 10:90 to 99:1, more advantageously 25:75 to 75:25, and most advantageously 35:65 to 65/35.

The total content of the binder component (A) is preferably 10% by mass or more and 99% by mass or less, more preferably 25% by mass or more and 75% by mass or less, and most preferably 35% by mass or more and 65% by mass or less, relative to the total amount of the binder. From the viewpoint of the abrasion resistance, water resistance, and alcohol resistance of the coating film formed with the silver nanowire composition and the adhesiveness between the film and a substrate, the total content of the binder component (A) is advantageously 99% by mass or less relative to the total amount of the binder. Furthermore, from the viewpoint of the abrasion resistance of the film and the adhesiveness between the film and a substrate, the total content of the component (A) is advantageously 75% by mass or less. From the viewpoint of the preservation stability and coating suitability of the silver nanowire composition and the conductivity, transparency, and turbidity of the film, however, the total content of the component (A) is advantageously 10% by mass or more. Furthermore, from the viewpoint of the conductivity of the film, the total content of the component (A) is more advantageously 25% by mass or more.

The total content of the binder component (B) is preferably 1% by mass or more and 90% by mass or less, more preferably 25% by mass or more and 75% by mass or less, and most preferably 35% by mass or more and 65% by mass or less, relative to the total amount of the binder. From the viewpoint of the abrasion resistance, water resistance, alcohol resistance of the coating film formed with the silver nanowire composition and the adhesiveness between the film and a substrate, the total content of the binder component (B) is advantageously 1% by mass or more relative to the total amount of the binder. Furthermore, from the viewpoint of the abrasion resistance of the film and the adhesiveness between the film and a substrate, the total content of the component (B) is advantageously 25% by mass or more. From the viewpoint of the preservation stability and coating suitability of the silver nanowire composition and the conductivity, transparency, and turbidity of the film, however, the total content of the component (B) is advantageously 90% by mass or less. Furthermore, from the viewpoint of the conductivity of the film, the total content of the component (B) is advantageously 75% by mass or less.

### [Surfactant]

The surfactant of the present invention may be any compound having a surface activating function. The surfactant facilitates the dispersion of the silver nanowires in the silver nanowire-containing composition, which probably contributes to the high preservation stability of the silver nanowire-containing composition and the high conductivity and transparency and the low turbidity of the coating film formed with the silver nanowire-containing composition. Examples of the surfactant include nonionic surfactants, anionic surfactants, cationic surfactants, and ampholytic surfactants. These surfactants may be used alone or in combination. The surfactant is preferably a nonionic surfactant from the viewpoint of the preservation stability of the silver nanowire composition and the conductivity and durability of the film.

Examples of the nonionic surfactant include polyoxyethylene alkyl ethers, polyoxyethylene alkylphenyl ethers, polyoxyethylene polycyclic phenyl ethers, polyoxyalkylene alkyl ethers, polyoxyethylene sorbitan esters, polyoxyethylene sorbitol fatty acid esters, sucrose fatty acid esters, and alkylimidazolines. From the viewpoint of the preservation stability of the silver nanowire composition and the conductivity and durability of the film, preferred are polyoxyethylene alkyl ethers, polyoxyethylene polycyclic phenyl ethers, polyoxyalkylene alkyl ethers, polyoxyethylene sorbitan esters, and alkylimidazolines; and more preferred are polyoxyethylene alkyl ethers, polyoxyethylene polycyclic phenyl ethers, and alkylimidazolines. These nonionic surfactant may be used alone or in combination.

Examples of the anionic surfactant include alkylbenzene sulfonates, alkylsulfates, polyoxyethylene alkyl ether sulfates, and polyoxyethylene polycyclic phenyl ether sulfates. These anionic surfactants may be used alone or in combination.

Examples of the cationic surfactant include alkylamine salts, tetraalkylammonium salts, and trialkylbenzylammonium salts. These cationic surfactants may be used alone or in combination.

Examples of the ampholytic surfactant include alkylbetaines and alkylamine oxides. These ampholytic surfactants may be used alone or in combination.

In the present invention, the content of the surfactant is preferably 0.01% by mass or more and 20% by mass or less, more preferably 0.05% by mass or more and 10% by mass or less, and most preferably 0.1% by mass or more and 5% by mass or less, relative to the amount of the silver nanowires. In the case that the composition of the present invention is used for a transparent conductive film, a content of the surfactant of 0.01% by mass or more is advantageous and preferred in order to prevent entanglement of the silver nanowires and to improve the preservation stability of the silver nanowire composition and the transparency, turbidity, and conductivity of the coating film formed with the silver nanowire composition. In order to improve the water resistance, alcohol resistance, and adhesiveness between the film and a substrate, however, a content of 20% by mass or less is advantageous and preferred.

### [Solvent]

The silver nanowire-containing composition of the present invention contains a solvent. The solvent serves as a dispersion medium for the silver nanowires and also a medium for dissolving other components in the silver nanowire-containing composition and evaporates in a process of forming a film, resulting in the formation of a uniform film. In the present invention, examples of the solvent include water and alcohols. Examples of the alcohols include methanol, ethanol, 1-propanol, 2-propanol, 1-butanol, 2-butanol, 2-methylpropanol, 1,1-dimethylethanol, cyclohexanol, ethylene glycol, propylene glycol, 1,3-butanediol, 1,4-butanediol, 1-methoxy-2-propanol diethylene glycol, glycerin, terpineol, and ethyl diethylene glycol. In the present invention, the solvent is preferably water, methanol, ethanol, 1-propanol, 2-propanol, propylene glycol, 1,3-butanediol, or 1,4-butanediol, from the viewpoint of the preservation stability of the silver nanowire composition and the conductivity of the film. These solvents may be used alone or in combination.

### [Silane Coupling Agent]

The silver nanowire-containing composition of the present invention may further contain a silane coupling agent in order to enhance the adhesiveness between the coating film formed with the silver nanowire-containing composition and a substrate and to enhance the abrasion resistance, water resistance, and alcohol resistance of the film. The silane coupling agent may be any compound having an alkoxysilyl group and a reactive functional group in one molecule. Examples of the reactive functional group include epoxy, vinyl, acrylic, amino, and mercapto groups. Examples of the silane coupling agent include alkylalkoxysilanes, such as vinyltrimethoxysilane, vinyltriethoxysilane, 3-methacryloyloxypropyltrimethoxysilane, 3-methacryloyloxypropyltriethoxysilane, 3-aminopropyltriethoxysilane, 3-glycidoxypropyltrimethoxysilane, 3-chloropropyltrimethoxysilane, 3-mercaptopropyltrimethoxysilane, n-propyltriethoxysilane, and n-octyltriethoxysilane; and polyether-modified alkoxysilanes. These silane coupling agents may be used alone or in combination.

### [Polyisocyanate Compound]

The silver nanowire-containing composition of the present invention may further contain a polyisocyanate compound in order to enhance the adhesiveness between the coating film formed with the silver nanowire-containing composition and a substrate and to enhance the abrasion resistance, water resistance, and alcohol resistance of the film. The polyisocyanate compound may be any compound having two or more isocyanate groups in one molecule. Examples of the polyisocyanate compound include trimethylene diisocyanate, 1,6-hexamethylene diisocyanate, tolylene diisocyanate, diphenylmethane diisocyanate, and isophorone diisocyanate; and multimers, such as adducts, biurets, and isocyanurates, of these diisocyanate monomers. In addition, block isocyanates prepared by blocking the isocyanate groups of these polyisocyanate compounds with compounds, such as ε-caprolactam, phenol, cresol, oxime, or alcohol, can be optionally used. These polyisocyanate compounds may be used alone or in combination.

### [Photoinitiator, Thermal Polymerization Initiator, Polymerizable Monomer, and Macromonomer]

The silver nanowire-containing composition of the present invention may further contain at least one of a photoinitiator and a thermal polymerization initiator and at least one of a polymerizable monomer and a macromonomer, in order to enhance the adhesiveness between the coating film formed with the silver nanowire-containing composition and a substrate and to enhance the abrasion resistance, water resistance, and alcohol resistance of the film.

### [Photoinitiator]

The photoinitiator may be any initiator that initiates polymerization by light irradiation. Examples of the photoinitiator include diethoxyacetophenone, 2-hydroxy-2-methyl-1-phenylpropan-1-one, 1-[4-(2-hydroxyethoxy)-phenyl]-2-hydroxy-2-methyl-1-propan-1-one, benzoin, benzoin methyl ether, benzoin ethyl ether, benzoylbenzoic acid, methyl benzoylbenzoate, 2-methyl-1-[4-(methylthio)phenyl]-2-(4-morpholinyl)-1-propanone, xanthone, anthraquinone, and 2-methylanthraquinone. These photoinitiators may be used alone or in combination.

### [Thermal Polymerization Initiator]

The thermal polymerization initiator may be any initiator that initiates polymerization by heat irradiation. Examples of the thermal polymerization initiator include persulfates, such as ammonium persulfate, sodium persulfate, and potassium persulfate; peroxides, such as t-butyl hydroperoxide, cumene hydroperoxide, benzoyl peroxide, and lauroyl peroxide; redox initiators, such as combinations of a persulfate or peroxide and a reducing agent such as a sulfite, bisulfite, thiosulfate, sodium formaldehyde sulfoxylate, ferrous sulfate, ammonium ferrous sulfate, glucose, or ascorbic acid; and azo compounds, such as 2,2′-azobisisobutyronitrile, 2,2′-azobis(2,4-dimethylvaleronitrile), 2,2′-azobis(2-methylbutyronitrile), dimethyl 2,2′-azobis(2-methylpropionate), and 2,2′-azobis(2-amidinopropane)dihydrochloride. These thermal polymerization initiators may be used alone or in combination.

### [Polymerizable Monomer and Macromonomer]

The polymerizable monomer and the macromonomer may be any monomer and any macromonomer that polymerize by irradiation with visible light or ionizing radiation, such as ultraviolet rays or electron rays, directly or with an action of an initiator. Examples of the polymerizable monomer having one functional group in one molecule include (meth)acrylate esters, such as (meth)acrylic acid, methyl(meth)acrylate, ethyl(meth)acrylate, butyl(meth)acrylate, 2-ethylhexyl(meth)acrylate, cyclohexyl(meth)acrylate, phenoxyethyl(meth)acrylate, 2-hydroxyethyl(meth)acrylate, methoxy-diethylene glycol(meth)acrylate, and methoxy-triethylene glycol(meth)acrylate; (meth)allyl compounds, such as (meth)allyl alcohol and glycerol mono(meth)allyl ether; aromatic vinyls, such as styrene, methylstyrene, and butylstyrene; carboxylic acid vinyl esters, such as vinyl acetate; (meth)acrylamides, such as (meth)acrylamide, N-cyclohexyl(meth)acrylamide, N-phenyl(meth)acrylamide, and N-(2-hydroxyethyl)(meth)acrylamide. Examples of the polymerizable monomer having two or more functional groups in one molecule include polyethylene glycol di(meth)acrylate, trimethylolpropane tri(meth)acrylate, pentaerythritol(meth)acrylate, alkyl-modified dipentaerythritol pentaerythritol, and ethylene oxide-modified bisphenol A di(meth)acrylate. Examples of the macromonomer include polymerizable urethane acrylic resins, polymerizable polyurethane resins, polymerizable acrylic resins, polymerizable epoxy resins, and polymerizable polyester resins having one or more polymerizable unsaturated groups in average in one molecule. These monomers and the macromonomers may be used alone or in combination.

The silver nanowire-containing composition of the present invention may contain optional components, such as a corrosion inhibitor, a pH adjuster, a conductive aid, and a thickener, in amounts that can maintain the required characteristics of the composition.

The corrosion inhibitor may be any compound that can prevent metal products from rusting. Examples of the corrosion inhibitor include imidazoles, such as imidazole and 1-methylimidazole; benzoimidazoles, such as benzoimidazole and 1-methylbenzoimidazole; benzotriazoles, such as benzotriazole and 1-methylbenzotriazole; tetrazoles, such as 1H-tetrazole; thiazoles, such as thiazole and 2-methylthiazole; benzothiazoles, such as benzothiazole and 2-methylbenzothiazole; and thiadiazoles, such as 2,5-dimercapto-1,3,4-thiadiazole. These corrosion inhibitors may be used alone or in combination.

The pH adjuster is a compound for adjusting the pH of the silver nanowire-containing composition. Examples of the pH adjuster include hydrochloric acid, sulfuric acid, acetic acid, sodium hydroxide, potassium hydroxide, and ammonia. These pH adjusters may be used alone or in combination.

The conductive aid may be any compound that can further enhance the conductivity of the silver nanowire-containing composition. Examples of the conductive aid include polymers, such as substituted or unsubstituted polyanilines, substituted or unsubstituted polypyrroles, substituted or unsubstituted polythiophenes, and copolymers of two or more of precursor monomers of these conductive polymers; microparticles of metals, alloys, and conductive metal oxides; and carbon structures, such as carbon nanotubes and graphenes. These conductive aids may be used alone or in combination.

The thickener may be any compound that can increase the viscosity of the silver nanowire-containing composition. Examples of the thickener include alkaline thickeners and urethane thickeners. These thickeners may be used alone or in combination.

The silver nanowire-containing composition of the present invention can be produced from the above-mentioned components by appropriately selected known processes, such as stirring, mixing, heating, cooling, dissolving, and dispersing.

The silver nanowire-containing composition of the present invention can be used for producing a substrate provided with a transparent conductive film. A film having satisfactory transparency, turbidity, and conductivity and also having high water resistance, abrasion resistance, alcohol resistance, and adhesiveness to a substrate can be formed on a substrate by applying the metal nanowire-containing composition of the present invention onto the substrate and then removing the solvent. The substrate can be appropriately selected depending on the use of the substrate and may be hard or flexible. The substrate may be colored. Examples of the material of the substrate include glass, polyimides, polycarbonates, polyether sulfones, polyacrylates, polyesters, polyethylene terephthalates, polyethylene naphthalates, polyolefins, and poly(vinyl chlorides). The substrate may be further provided with an organic or inorganic functional material. Furthermore, the substrate may be composed of two or more layers.

The silver nanowire-containing composition of the present invention can be applied to a substrate by a known process. Examples of the process of application of the silver nanowire-containing composition of the present invention to a substrate include spin coating, slit coating, dip coating, blade coating, bar coating, spraying, relief printing, intaglio printing, screen printing, lithography, dispensing, and ink jetting. The composition may be applied two or more times by such a process.

The silver nanowire-containing composition of the present invention may be diluted to an appropriate concentration depending on the coating process. Examples of the diluent include water and alcohols. In the present invention, the diluent is preferably water, methanol, ethanol, 1-propanol, 2-propanol, propylene glycol, 1,3-butanediol, or 1,4-butanediol. These diluents may be used alone or in combination.

The silver nanowire-containing composition of the present invention has high preservation stability and coating suitability and can form a transparent conductive film having satisfactory transparency, turbidity, and conductivity and also having high water resistance, abrasion resistance, alcohol resistance, and adhesiveness to a substrate. Accordingly, the silver nanowire-containing composition can be widely used, for example, for forming transparent conductive films of various types of devices, such as electrode components of liquid crystal displays, electrode components of plasma displays, electrode components of organic electroluminescent displays, electrode components of electronic paper, electrode components of touch panels, electrode components of thin-film amorphous Si solar cells, electrode components of dye-sensitized solar cells, electromagnetic shielding components, and antistatic components.

### EXAMPLES

The present invention will now be specifically described by way of the following Examples, which are not intended to limit the invention. Note that the terms “part(s)” and “%” in Examples and Comparative Examples are based on mass, unless otherwise specified and that in Examples and Comparative Examples, the water used as a component is pure water, and the film formed by applying a silver nanowire-containing composition to a substrate and then removing the solvent may be referred to as a silver nanowire-containing film. The measurement and evaluation in each evaluation item are as follows.

### [Diameter of Silver Nanowires]

One hundred silver nanowires were observed with a scanning electron microscope (SEM: manufactured by JEOL Ltd., JSM-5610LV), and the diameter of the silver nanowires was determined from the arithmetic mean value.

### [Major-Axis Length of Silver Nanowires]

One hundred silver nanowires were observed with a scanning electron microscope (SEM: manufactured by JEOL Ltd., JSM-5610LV), and the major-axis length of the silver nanowires was determined from the arithmetic mean value.

### [Preservation Stability of Silver Nanowire-Containing Composition]

A test tube filled with a silver nanowire-containing composition was placed in a test tube rack and was left to stand in a dark place at room temperature for one month. The height of the whole silver nanowire-containing composition and the height of the generated supernatant portion were then measured, and the proportion of the generated supernatant was calculated by the expression shown below and was ranked. Furthermore, the tube was shaken by a hand ten times in a reciprocating motion, and the state of the redispersion of the silver nanowires was visually observed. Herein, the term “supernatant” refers to the dilute portion of the silver nanowire-containing composition in which the concentration of the silver nanotubes is decreased by precipitation and the composition is visually transparent or semitransparent.

Proportion (%) of generated supernatant=(height of supernatant portion)/(height of the whole silver nanowire-containing composition)×100.

Evaluation Criteria:
A: the proportion of generated supernatant is less than 5%, and the redispersion is satisfactory;
B: the proportion of generated supernatant is 5% or more and less than 25%, and the redispersion is satisfactory;
B/C: the proportion of generated supernatant is 25% or more, and the redispersion is satisfactory;
C: the proportion of generated supernatant is 25% or more, and the redispersion is poor; and
D: almost all of the silver nanowires are precipitated, and the redispersion is poor.

### [Coating Suitability of Silver Nanowire-Containing Composition]

A silver nanowire-containing composition was diluted with pure water or ethanol such that the content of the silver nanowires was 0.2% by mass and was applied onto a PET substrate A4100 (manufactured by Toyobo Co., Ltd.) (hereinafter, may be referred to as PET substrate) with bar coater #4. The coating suitability of the silver nanowire-containing composition was visually determined by the following criteria:
A: no repellency is observed;
B: slight repellency is observed at the end of the substrate;
C: clear repellency is observed at many portions of the substrate; and
D: no film is formed because of high repellency.

### [Average Surface Electric Resistance of Silver Nanowire-Containing Film]

The PET substrate after application of the silver nanowire-containing composition used for evaluation of the coating suitability was dried in a drier at 110° C. for 3 minutes, or was dried in a drier at 110° C. for 3 minutes and was then irradiated with UV light of 500 mJ/cm² with an ultraviolet irradiation device UV1501C-SZ (manufactured by Cell Engineering Co., Ltd.) to prepare a silver nanowire-containing film. The surface electric resistance (Ω/□) was measured at ten different points on the PET substrate provided with the silver nanowire layer, and the average surface electric resistance of the silver nanowire-containing film was determined from the arithmetic mean value. Since the silver nanowire-containing composition used for evaluation of the coating suitability applied to the PET substrate has uniform silver nanowire content on the PET substrate, the coating film also probably has a uniform silver nanowire content. Accordingly, the evaluation of the average surface electric resistance of a silver nanowire-containing film can be used for evaluation of the conductivity of a silver nanowire-containing film having the same content. A lower average surface electric resistance indicates a higher conductivity of the silver nanowire-containing film. The surface electric resistance was measured by a four-point probe method (in accordance with JIS K 7194) with Loresta-GP MCP-T610 (manufactured by Mitsubishi Chemical Corporation).

### [Uniformity of Surface Electric Resistance of Silver Nanowire-Containing Film]

The surface electric resistance (Ω/□) was measured at ten different points on the PET substrate after application of the silver nanowire-containing composition used for the evaluation of average surface electric resistance, and the coefficient of variation was determined. The coefficient of variation is determined by dividing the standard deviation of the surface electric resistance (Ω/□) measured at ten different points on one silver nanowire-containing film by the average surface electric resistance (Ω/□). A smaller coefficient of variation indicates higher uniformity of the surface electric resistance of the silver nanowire-containing film. The surface electric resistance was measured by a four-point probe method (in accordance with JIS K 7194) with Loresta-GP MCP-T610 (manufactured by Mitsubishi Chemical Corporation).

### [Variation in Total Light Transmittance of Substrate by Silver Nanowire-Containing Film]

The total light transmittance of a PET substrate before application of the composition and the total light transmittance of the PET substrate after application of the silver nanowire-containing composition used in the evaluation of average surface electric resistance were measured, and the variation in the total light transmittance of the PET substrate due to the silver nanowire-containing film was determined from the difference. The variation in total light transmittance generally has a negative value, and a lower absolute value thereof indicates higher transparency of the silver nanowire-containing film. The total light transmittance was measured with NDH5000 (manufactured by Nippon Denshoku Industries Co., Ltd.).

### [Variation in Haze of Substrate by Silver Nanowire-Containing Film]

The haze of a PET substrate before application of the composition and the haze of the PET substrate after application of the silver nanowire-containing composition used in the evaluation of average surface electric resistance were measured, and the variation in the haze of the PET substrate due to the silver nanowire-containing film was determined from the difference. A lower variation in haze indicates lower turbidity of the silver nanowire-containing film. The haze was measured with NDH5000 (manufactured by Nippon Denshoku Industries Co., Ltd.).

### [Abrasion Resistance of Silver Nanowire-Containing Film]

A dry nonwoven fabric was placed on a PET substrate after application of the silver nanowire-containing composition used for the evaluation of average surface electric resistance, and was reciprocated ten times across the film under a load of 100 g/cm². The rate of change in the surface electric resistance from that before the test was determined.
A: a rate of change of 0% or more and less than 5%;
B: a rate of change of 5% or more and less than 50%;
C: a rate of change of 50% or more and less than 500%; and
D: a rate of change of 500% or more.

### [Water Resistance of Silver Nanowire-Containing Film]

A nonwoven fabric wetted with pure water was placed on a PET substrate after application of the silver nanowire-containing composition used for the evaluation of average surface electric resistance, and was reciprocated ten times across the film under a load of 100 g/cm². The rate of change in the surface electric resistance from that before the test was determined.
A: a rate of change of 0% or more and less than 10%;
B: a rate of change of 10% or more and less than 100%;
C: a rate of change of 100% or more and less than 500%; and
D: a rate of change of 500% or more.

### [Alcohol Resistance of Silver Nanowire-Containing Film]

A nonwoven fabric wetted with 2-propanol was placed on a PET substrate after application of the silver nanowire-containing composition used for the evaluation of average surface electric resistance, and was reciprocated ten times across the film under a load of 100 g/cm². The rate of change in the surface electric resistance from that before the test was determined.
A: a rate of change of 0% or more and less than 20%;
B: a rate of change of 20% or more and less than 200%;
C: a rate of change of 200% or more and less than 1000%; and
D: a rate of change of 1000% or more.

### [Adhesiveness to a Substrate of Silver Nanowire-Containing Film]

On the PET substrate after application of the silver nanowire-containing composition used for the evaluation of average surface electric resistance, 25 grids (5×5) were formed in accordance with the cross-cut adhesion test described in JIS K5400 and the substrate was subjected to a peeling test using an adhesive cellophane tape to evaluate the adhesiveness of the silver nanowire-containing film to a substrate by the following criteria:
A: no peeling;
B: 1≦number of peeling positions<10
C: 10≦number of peeling positions<50; and
D: 50≦number of peeling positions.

### [Preparation of Silver Nanowire Dispersion (1)]

Under light shielding, 1.04 parts by mass of a N-(2-hydroxyethyl)acrylamide polymer, a silver nanowire integration regulator, having an weight-average molecular weight of 500000 and 97.9 parts by mass of ethylene glycol were placed in a four-necked flask provided with a stirrer, a thermometer, and a nitrogen-introducing tube (hereinafter, “four-necked flask provided with a stirrer, a thermometer, and a nitrogen-introducing tube” is abbreviated to “four-necked flask”) under a nitrogen stream, and were stirred at 120° C. for dissolution.

To the solution were added 10.0 parts by mass of ethylene glycol and 0.0064 parts by mass of ammonium chloride. The mixture was heated to 140° C. and was stirred for 15 minutes. To the mixture were further added 40.0 parts by mass of ethylene glycol and 1.02 parts by mass of silver nitrate. The mixture was stirred at 140° C. for 45 minutes to prepare silver nanowires. A large excess of water was added to the resulting silver nanowire dispersion. The silver nanowire component was collected by filtration, and the residue was redispersed in water. This procedure was repeated several times to purify the silver nanowire component and to prepare a silver nanowire dispersion (1) containing 17.5% by mass silver nanowires. The resulting silver nanowires had an average major-axis length of 24 and an average diameter of 71 nm.

### [Preparation of Silver Nanowire Dispersion (2)]

As in the preparation of the silver nanowire dispersion (1), 1.11 parts by mass of a vinylpyrrolidone polymer (product of Kanto Chemical Co., Ltd., product name: Polyvinylpyrrolidone K=30), a silver nanowire integration regulator, having a weight-average molecular weight of 40000 and 147.7 parts by mass of ethylene glycol were stirred at 25° C. for dissolution. To the solution were added 0.0186 parts by mass of sodium chloride and 1.13 parts by mass of silver nitrate. The mixture was stirred at 25° C. for 15 minutes. The temperature of the mixture was then increased to 150° C. over 5 minutes. The mixture was further stirred for 30 minutes to prepare silver nanowires. A large excess of pure water was added to the resulting silver nanowire dispersion. The silver nanowire component was collected by filtration, and the residue was redispersed in water. This procedure was repeated several times to purify the silver nanowire component and to prepare a silver nanowire dispersion (2) containing 5.0% by mass silver nanowires. The resulting silver nanowires had an average major-axis length of 14 μm and an average diameter of 155 nm.

### [Preparation of Binder Component (A)]

In a four-necked flask were placed 20 parts by mass of hydroxypropyl guar gum (product of Sansho Co., Ltd., product name: HP-8) and 980 parts by mass of pure water. The mixture was then stirred at room temperature for 6 hours to prepare a binder (A-1), which was a hydroxypropyl guar gum dispersion containing 2.0% by mass hydroxypropyl guar gum.

Binders (A-2) to (A-10) each containing 2.0% by mass saccharide were prepared as in the preparation of the binder (A-1) except that the polysaccharide and solvent used were those shown in Table 1.

TABLE 1

| | Polysaccharide | Solvent |
|---|---|---|
| Binder (A-1) | Hydroxypropyl guar gum | Water |
| | (product of Sansho Co., Ltd., product name: HP-8) | |
| Binder (A-2) | Methyl cellulose | Water |
| | (product of Shin-Etsu Chemical Co., Ltd., product name: Metolose | |
| | SM8000) | |
| Binder (A-3) | Hydroxypropyl methyl cellulose | Water |
| | (product of Shin-Etsu Chemical Co., Ltd., product name: Metolose | |
| | 90SH15000) | |
| Binder (A-4) | Hydroxypropyl cellulose | Water |
| | (product of Nippon Soda Co., Ltd., product name: HPC-L) | |
| Binder (A-5) | Hydroxypropyl cellulose | Ethanol |
| | (product of Nippon Soda Co., Ltd., product name: HPC-L) | |
| Binder (A-6) | Carboxymethyl cellulose sodium salt | Water |
| | (product of Daicel Corporation, product name: CMC Daicel 1350) | |
| Binder (A-7) | Hydroxyethyl cellulose | Water |
| | (product of Daicel Corporation, product name: HEC Daicel SP400) | |
| Binder (A-8) | Poly(vinyl alcohol) | Water |
| | (product of Kuraray Co., Ltd., product name: Kuraray Poval PVA217) | |
| Binder (A-9) | Poly(ethylene oxide) | Water |
| | (product of Meisei Chemical Works, Ltd., product name: Alcox E-75) | |
| Binder (A-10) | Polyvinylpyrrolidone | Water |
| | (product of Kanto Chemical Co., Ltd., product name: | |
| | Polyvinylpyrrolidone K = 30) | |

In a four-necked flask were placed 20 parts by mass of hydroxypropyl guar gum (product of Sansho Co., Ltd., product name: HP-8) and 950 parts by mass of pure water. Furthermore, 0.3 parts by mass of 5% by mass phosphoric acid was added thereto. The mixture was heated to 50° C., and 0.1 parts by mass of N-methylolacrylamide was added thereto, followed by stirring for 6 hours. The mixture was heated to 70° C., and 15 parts by mass of methyl methacrylate, 5 parts by mass of n-butyl acrylate, and 8 parts by mass of 1% by mass aqueous ammonium persulfate solution were added thereto under a nitrogen gas stream. The mixture was stirred for 3 hours. As a result, a binder (A-11), which was a dispersion containing 4.0% by mass hydroxypropyl guar gum graft-polymerized with a (meth)acrylate ester, was synthesized.

A binder (A-12) was synthesized as in the binder (A-11) except that methyl cellulose (product of Shin-Etsu Chemical Co., Ltd., product name: Metolose SM8000) was used instead of the hydroxypropyl guar gum such that the binder (A-12) was a dispersion containing 4.0% by mass methyl cellulose graft-polymerized with a (meth)acrylate ester.

A binder (A-13) was synthesized as in the binder (A-11) except that hydroxypropyl methyl cellulose (product of Shin-Etsu Chemical Co., Ltd., product name: Metolose 90SH15000) was used instead of the hydroxypropyl guar gum such that the binder (A-13) was a dispersion containing 4.0% by mass hydroxypropyl methyl cellulose graft-polymerized with a (meth)acrylate ester.

### [Synthesis of Binder Component (B)]

In a four-necked flask were placed 106 parts by mass of dimethyl terephthalate, 78 parts by mass of dimethyl isophthalate, 18 parts by mass of dimethyl sodium 5-sulfoisophthalate, 124 parts by mass of ethylene glycol, and 0.8 parts by mass of anhydrous sodium acetate under a nitrogen gas stream. The mixture was then heated to 150° C. with stirring, was further heated to 180° C. while distilling the produced methanol from the system, and was stirred for 3 hours. To the mixture was added 0.2 parts by mass of tetra-n-butyltitanate. The mixture was heated to 230° C. with stirring, was stirred for 7 hours while distilling the produced ethylene glycol from the system under a reduced pressure of 10 hPa, and was then cooled to 180° C. To the mixture was added 1 part by mass of trimellitic anhydride. The mixture was stirred for 3 hours and was then cooled to room temperature. As a result, an aqueous polyester resin (B-1) was synthesized.

In a four-necked flask were placed 100 parts by mass of the aqueous polyester resin (B-1) and 900 parts by mass of pure water. The mixture was then stirred at room temperature for 6 hours to prepare a binder (B-2), which was an aqueous polyester resin dispersion containing 10.0% by mass aqueous polyester resin.

In a four-necked flask were placed 200 parts by mass of the aqueous polyester resin (B-1) and 298 parts by mass of pure water. The mixture was heated to 60° C. with stirring to dissolve the aqueous polyester resin, and 2.5 parts by mass of glycidyl methacrylate was added thereto, followed by stirring for 1 hour. Furthermore, 279 parts by mass of pure water was added thereto, and the mixture was cooled to 40° C. with stirring. To the mixture were added 37.5 parts by mass of methyl methacrylate and 12.5 parts by mass of n-butyl acrylate. The mixture was heated to 70° C. with stirring, and 4 parts by mass of 1% by mass ammonium persulfate was added thereto under a nitrogen gas stream, followed by stirring for 4 hours. Furthermore, 167 parts by mass of pure water was added thereto. As a result, a binder (B-3), which was a dispersion containing 10.0% by mass aqueous polyester resin graft-polymerized with a (meth)acrylate ester, was synthesized.

In a four-necked flask were placed 8.0 parts by mass of 2-butyl-2-ethyl-1,3-propanediol, 50 parts by mass of acetone, and 0.017 parts by mass of dibutyl didodecane tin, under a nitrogen gas stream. The mixture was heated to 40° C. with stirring, and 22.7 parts by mass of isophorone diisocyanate was added thereto. The mixture was refluxed at 60° C. for 1 hour and was then cooled to 50° C., followed by addition of 6.0 parts by mass of N-methyldiethanolamine thereto. The mixture was further stirred for 1 hour, and parts by mass of 6% by mass acetic acid was added thereto. The mixture was diluted with 100 parts by mass of pure water, and the acetone was distilled away under reduced pressure. As a result, a binder (B-4), which was an aqueous polyurethane resin dispersion containing 22.0% by mass aqueous polyurethane resin, was synthesized.

In a four-necked flask were added 604 parts by mass of pure water, 10 parts by mass of 2-propanol, 60 parts by mass of methyl methacrylate, 83 parts by mass of n-butyl acrylate, 102 parts by mass of 2-ethylhexyl acrylate, 15 parts by mass of 80% by mass methacrylic acid, 67 parts by mass of 50% by mass acrylamide, and 10 parts by mass of sodium dodecylbenzenesulfonate, under a nitrogen gas stream. The mixture was heated to 40° C. with stirring, and 16 parts by mass of 25% by mass ammonium persulfate and 13 parts by mass of 25% by mass sodium bisulfite were added thereto. The mixture was stirred at 80° C. for 3 hours and was then cooled to room temperature, followed by adjustment of the pH to 6.8 with triethylamine. As a result, a binder (B-5), which was an aqueous acrylic resin dispersion containing 30.0% by mass aqueous acrylic resin, was synthesized.

### <Synthesis of Fatty Acid Amide Solution (1)>

In a four-necked flask were placed 578 parts by mass of an unsaturated fatty acid mixture of oleic acid and linoleic acid (product of NOF Corporation, product name: NAA-300) and 146 parts by mass of triethylenetetramine (product of Tosoh Corporation, product name: TETA). The mixture was heated to 175° C. over 2 hours in a nitrogen gas stream and was further retained at 175° C. for at least 7 hours for continuing the reaction at this temperature until the acid value of the content was decreased to 5 or less. After cooling, the content was diluted with butyl cellosolve into a solid content of 80%. As a result, a fatty acid amide solution (1) was prepared.

### <Synthesis of Fatty Acid Amide Solution (2)>

In a four-necked flask were placed 578 parts by mass of an unsaturated fatty acid mixture of oleic acid and linoleic acid (product of NOF Corporation, product name: NAA-300) and 103 parts by mass of diethylenetriamine (product of Tosoh Corporation, product name: DETA). The mixture was heated to 175° C. over 2 hours in a nitrogen gas stream and was further retained at 175° C. for at least 7 hours for continuing the reaction at this temperature until the acid value of the content was decreased to 5 or less. After cooling, the content was diluted with butyl cellosolve to a solid content of 80%. As a result, a fatty acid amide solution (2) was prepared.

### <Synthesis of Aqueous Epoxy Resin Dispersion>

In a four-necked flask were placed 73.9 parts by mass of bisphenol A epoxy oligomer (product of DIC Corporation, product name: Epiclon 7050, epoxy equivalent: 1980), 58.4 parts by mass of bisphenol A epoxy oligomer (product of DIC Corporation, product name: Epiclon 4050, epoxy equivalent: 950), and 56.7 parts by mass of butyl cellosolve. The mixture was dissolved at 100° C. in a nitrogen gas stream. The solution was mixed with 4.5 parts by mass of polyoxypropylene diglycidyl ether (product of Nagase ChemteX Corporation, product name: Denacol EX-920) and 1.9 parts by mass of butyl cellosolve. The temperature in the reactor was then reduced to 90° C., and 1.2 parts by mass of diallylamine was added to the reaction solution. After the reaction for 15 minutes, 21.1 parts by mass of the fatty acid amide solution (1), 39.5 parts by mass of the fatty acid amide solution (2), and 9.1 parts by mass of butyl cellosolve were added to the reaction solution, followed by a reaction at 90° C. for 2 hours. As a result, a fatty acid amide-modified epoxy resin was prepared.

Subsequently, in a state of maintaining the temperature in the reactor at 90° C., to the fatty acid amide-modified epoxy resin was dropwise added a mixture of 12.3 parts by mass of acrylic acid, 4.2 parts by mass of styrene, 4.2 parts by mass of butyl acrylate, 8.9 parts by mass of butyl cellosolve, and 1.7 parts by mass of an organic peroxide initiator (product of Kayaku Akzo Co., Ltd., product name: Kayaester 0), over 30 minutes. The mixture was reacted for 2 hours. After cooling to 85° C., 15.5 parts by mass of triethylamine and 272 parts by mass of pure water were sequentially added to and mixed with the reaction solution for neutralization and dispersion into water. As a result, a binder (B-6), which was an aqueous epoxy resin dispersion containing 35.0% of nonvolatile component and having a pH of 9.5, was synthesized.

### Example 1

In a four-necked flask were placed 2.857 parts by mass of 17.5% by mass silver nanowire dispersion (1), 26.25 parts by mass of the binder (A-4) as a binder component (A), 0.75 parts by mass of the binder (B-5) as a binder component (B), 0.01 parts by mass of a polyoxyethylene alkyl ether (product of Nippon Nyukazai Co., Ltd., product name: Newcall 2308) as a surfactant, and 70.133 parts by mass of pure water as a solvent. The mixture was sufficiently stirred to prepare a silver nanowire-containing composition as a uniform dispersion. Table 5 shows the concentration and the mass ratio of each component of the silver nanowire-containing composition of Example 1. In application of the composition onto a substrate, the composition diluted 2.5 times with pure water such that the content of the silver nanowires was 0.2% by mass was used. Table 8 shows the results of precipitation test (“preservation stability”) and coating suitability test of the silver nanowire-containing composition of Example 1 and the results of the physical properties of the silver nanowire-containing film.

### Examples 2 to 35

Silver nanowire-containing compositions were prepared as in Example 1 except that the components in Example 1 were changed to those shown in Tables 2 to 4. As additional components, a silane coupling agent was used in Example 29; a polyisocyanate compound was used in Example 30; an alkaline thickener was used in Example 31; a urethane thickener was used in Example 32; and a photoinitiator and a polymerizable macromonomer were used in Example 34. Tables 5 to 7 show the concentration and the mass ratio of each component of the silver nanowire-containing compositions of Examples 2 to 35. In application of the composition onto a substrate, the silver nanowire-containing compositions of Examples 33 and 34 were diluted with ethanol and the compositions of other Examples were diluted with pure water such that the content of the silver nanowires was 0.2% by mass. In the silver nanowire-containing composition of Example 34, a silver nanowire-containing film was prepared by drying a PET substrate after application of the silver nanowire-containing composition used for evaluation of the coating suitability in a drier at 110° C. for 3 minutes and then irradiating the substrate with UV light of 500 mJ/cm² with an ultraviolet irradiation device UV1501C-SZ (manufactured by Cell Engineering Co., Ltd.). In other Examples, silver nanowire-containing films were prepared by drying PET substrates after application of the respective silver nanowire-containing compositions in a drier at 110° C. for 3 minutes. Tables 8 to 10 show the results of precipitation test and coating suitability test of the silver nanowire-containing compositions prepared in Examples 2 to 35 and the results of the physical properties of the silver nanowire-containing films.

### Comparative Examples 1 to 6

Silver nanowire-containing compositions were prepared as in Example 1 except that each component in Example 1 were changed to those shown in Table 3. Table 6 shows the concentration and the mass ratio of each component of the silver nanowire-containing compositions prepared in Comparative Examples 1 to 6. In application of each composition to a substrate, the composition was diluted with pure water such that the content of the silver nanowires was 0.2% by mass. Table 9 shows the results of precipitation test (“preservation stability”) and coating suitability test of the silver nanowire-containing compositions prepared in Comparative Examples 1 to 6 and the results of the physical properties of the silver nanowire-containing films.

TABLE 2

| | | Parts | | Parts | | Parts | | Parts | | Parts |
|---|---|---|---|---|---|---|---|---|---|---|
| | Silver nanowire | by | | by | | by | | by | | by |
| | dispersion | mass | Binder (A) | mass | Binder (B) | mass | Surfactant | mass | Solvent | mass |
| Example 1 | Silver nanowire | 2.857 | Binder (A-4) | 26.25 | Binder (B-5) | 0.75 | Polyoxyethylene alkyl ether | 0.01 | Pure water | 70.133 |
| | dispersion (1) | | | | | | | | | |
| Example 2 | Silver nanowire | 2.857 | Binder (A-4) | 26.25 | Binder (B-4) | 1.023 | Polyoxyethylene polycyclic | 0.01 | Pure water/ | 59.86/ |
| | dispersion (1) | | | | | | phenyl ether | | ethanol | 10 |
| Example 3 | Silver nanowire | 2.857 | Binder (A-4) | 26.25 | Binder (B-6) | 0.643 | Polyoxyethylene alkyl ether | 0.01 | Pure water | 70.240 |
| | dispersion (1) | | | | | | | | | |
| Example 4 | Silver nanowire | 2.857 | Binder (A-6) | 26.25 | Binder (B-5) | 0.75 | Polyoxyethylene alkyl ether | 0.01 | Pure water | 70.133 |
| | dispersion (1) | | | | | | | | | |
| Example 5 | Silver nanowire | 2.857 | Binder (A-7) | 26.25 | Binder (B-5) | 0.75 | Polyoxyethylene alkyl | 0.005/ | Pure water/ | 50.133/ |
| | dispersion (1) | | | | | | ether/alkylimidazoline | 0.005 | propylene | 20 |
| | | | | | | | | | glycol | |
| Example 6 | Silver nanowire | 2.857 | Binder (A-4) | 26.25 | Binder (B-2) | 2.25 | Polyoxyethylene alkyl ether | 0.01 | Pure water | 68.633 |
| | dispersion (1) | | | | | | | | | |
| Example 7 | Silver nanowire | 2.857 | Binder (A-1) | 26.25 | Binder (B-2) | 2.25 | Polyoxyethylene alkyl ether | 0.01 | Pure water | 68.633 |
| | dispersion (1) | | | | | | | | | |
| Example 8 | Silver nanowire | 2.857 | Binder (A-2) | 26.25 | Binder (B-2) | 2.25 | Polyoxyethylene alkyl ether | 0.01 | Pure water | 68.633 |
| | dispersion (1) | | | | | | | | | |
| Example 9 | Silver nanowire | 2.857 | Binder (A-3) | 26.25 | Binder (B-2) | 2.25 | Polyoxyethylene alkyl ether | 0.01 | Pure water | 68.633 |
| | dispersion (1) | | | | | | | | | |
| Example 10 | Silver nanowire | 2.857 | Binder (A-1) | 13.125 | Binder (B-2)/ | 2.25/ | Polyoxyethylene alkyl ether | 0.0002 | Pure water | 80.893 |
| | dispersion (1) | | | | Binder (B-5) | 0.875 | | | | |
| Example 11 | Silver nanowire | 2.857 | Binder (A-2) | 13.125 | Binder (B-2)/ | 2.25/ | Polyoxyethylene alkyl ether | 0.06 | Pure water | 80.833 |
| | dispersion (1) | | | | Binder (B-5) | 0.875 | | | | |
| Example 12 | Silver nanowire | 2.857 | Binder (A-3) | 36.75 | Binder (B-2)/ | 6.3/ | Polyoxyethylene alkyl ether | 0.01 | Pure water | 51.633 |
| | dispersion (1) | | | | Binder (B-5) | 2.45 | | | | |
| Example 13 | Silver nanowire | 2.857 | Binder (A-11) | 13.125 | Binder (B-2) | 2.25 | Polyoxyethylene alkyl ether | 0.0002 | Pure water | 81.768 |
| | dispersion (1) | | | | | | | | | |
| Example 14 | Silver nanowire | 2.857 | Binder (A-12) | 13.125 | Binder (B-2) | 2.25 | Polyoxyethylene alkyl ether | 0.06 | Pure water | 81.708 |
| | dispersion (1) | | | | | | | | | |
| Example 15 | Silver nanowire | 2.857 | Binder (A-13) | 36.75 | Binder (B-2) | 6.3 | Polyoxyethylene alkyl ether | 0.01 | Pure water | 54.083 |
| | dispersion (1) | | | | | | | | | |

TABLE 3

| | | Parts | | Parts | | Parts | | Parts | | Parts |
|---|---|---|---|---|---|---|---|---|---|---|
| | Silver nanowire | by | | by | | by | | by | | by |
| | dispersion | mass | Binder (A) | mass | Binder (B) | mass | Surfactant | mass | Solvent | mass |
| Example 16 | Silver nanowire | 14.286 | Binder (A-12) | 3.75 | Binder (B-2) | 0.6 | Polyoxyethylene alkyl ether | 0.005 | Pure water | 81.564 |
| | dispersion (1) | | | | | | | | | |
| Example 17 | Silver nanowire | 60.000 | Binder (A-13) | 29.4 | Binder (B-2) | 5.04 | Polyoxyethylene alkyl ether | 0.21 | Pure water | 5.350 |
| | dispersion (1) | | | | | | | | | |
| Example 18 | Silver nanowire | 2.857 | Binder (A-11) | 13.125 | Binder (B-2) | 2.25 | Polyoxyethylene alkyl ether | 0.0004 | Pure water | 81.768 |
| | dispersion (1) | | | | | | | | | |
| Example 19 | Silver nanowire | 2.857 | Binder (A-12) | 13.125 | Binder (B-2) | 2.25 | Polyoxyethylene alkyl ether | 0.04 | Pure water | 81.728 |
| | dispersion (1) | | | | | | | | | |
| Example 20 | Silver nanowire | 2.857 | Binder (A-13) | 32.813 | Binder (B-2) | 5.625 | Polyoxyethylene alkyl ether | 0.01 | Pure water | 58.695 |
| | dispersion (1) | | | | | | | | | |
| Example 21 | Silver nanowire | 14.286 | Binder (A-12) | 5.25 | Binder (B-2) | 0.9 | Polyoxyethylene alkyl ether | 0.05 | Pure water | 79.514 |
| | dispersion (1) | | | | | | | | | |
| Example 22 | Silver nanowire | 45.714 | Binder (A-13) | 22.4 | Binder (B-2) | 3.84 | Polyoxyethylene alkyl ether | 0.16 | Pure water | 27.886 |
| | dispersion (1) | | | | | | | | | |
| Example 23 | Sliver nanowire | 2.857 | Binder (A-11) | 15 | Binder (B-2) | 1.5 | Polyoxyethylene alkyl ether | 0.01 | Pure water | 80.633 |
| | dispersion (1) | | | | | | | | | |
| Example 24 | Silver nanowire | 2.857 | Binder (A-11) | 3.75 | Binder (B-2) | 6 | Polyoxyethylene alkyl ether | 0.01 | Pure water | 87.383 |
| | dispersion (1) | | | | | | | | | |
| Example 25 | Silver nanowire | 2.857 | Binder (A-11) | 13.125 | Binder (B-2) | 2.25 | Polyoxyethylene alkyl ether | 0.01 | Pure water | 81.758 |
| | dispersion (1) | | | | | | | | | |
| Example 26 | Silver nanowire | 2.857 | Binder (A-11) | 5.625 | Binder (B-2) | 5.25 | Polyoxyethylene alkyl ether | 0.01 | Pure water | 86.258 |
| | dispersion (1) | | | | | | | | | |
| Example 27 | Silver nanowire | 2.857 | Binder (A-11) | 9.375 | Binder (B-2) | 3.75 | Polyoxyethylene alkyl ether | 0.01 | Pure water | 84.008 |
| | dispersion (1) | | | | | | | | | |
| Example 28 | Silver nanowire | 2.857 | Binder (A-11) | 9.375 | Binder (B-3) | 3.75 | Polyoxyethylene alkyl ether | 0.01 | Pure water | 84.008 |
| | dispersion (1) | | | | | | | | | |
| Example 35 | Silver nanowire | 10.000 | Binder (A-1) | 26.25 | Binder (B-2) | 2.25 | Polyoxyethylene alkyl ether | 0.01 | Pure water | 61.490 |
| | dispersion (2) | | | | | | | | | |
| Comparative | Silver nanowire | 2.857 | Binder (A-8) | 26.25 | Binder (B-5) | 0.75 | Polyoxyethylene alkyl ether | 0.01 | Pure water | 70.133 |
| Example 1 | dispersion (1) | | | | | | | | | |
| Comparative | Silver nanowire | 2.857 | Binder (A-9) | 26.25 | Binder (B-5) | 0.75 | Polyoxyethylene alkyl ether | 0.01 | Pure water | 70.133 |
| Example 2 | dispersion (1) | | | | | | | | | |
| Comparative | Silver nanowire | 2.857 | Binder (A-10) | 26.25 | Binder (B-5) | 0.75 | Polyoxyethylene alkyl ether | 0.01 | Pure water | 70.133 |
| Example 3 | dispersion (1) | | | | | | | | | |

| | | | | | | | | | |
|---|---|---|---|---|---|---|---|---|---|
| Comparative | Silver nanowire | 2.857 | Binder (A-4) | 37.5 | — | Polyoxyethylene alkyl ether | 0.01 | Pure water | 59.633 |
| Example 4 | dispersion (1) | | | | | | | | |

| | | | | | | | | | |
|---|---|---|---|---|---|---|---|---|---|
| Comparative | Silver nanowire | 2.857 | Binder (A-4) | 26.25 | Binder (B-5) | 0.75 | — | Pure water | 70.143 |
| Example 5 | dispersion (1) | | | | | | | | |

| | | | | | | | | | |
|---|---|---|---|---|---|---|---|---|---|
| Comparative | Silver nanowire | 2.857 | — | Binder (B-5) | 2.5 | Polyoxyethylene alkyl ether | 0.01 | Pure water | 94.633 |
| Example 6 | dispersion (1) | | | | | | | | |

TABLE 4

| | | Parts | | Parts | | Parts | | Parts | | Parts | Other | Parts |
|---|---|---|---|---|---|---|---|---|---|---|---|---|
| | Silver nanowire | by | | by | | by | | by | | by | compo- | by |
| | dispersion | mass | Binder (A) | mass | Binder (B) | mass | Surfactant | mass | Solvent | mass | nent | mass |
| Example 29 | Silver nanowire | 2.857 | Binder (A-1) | 26.25 | Binder (B-2) | 2.25 | Polyoxyethylene | 0.01 | Pure | 58.558/ | Silane | 0.075 |
| | dispersion (1) | | | | | | alkyl ether | | water/ | 10 | coupling | |
| | | | | | | | | | ethanol | | agent | |
| Example 30 | Silver nanowire | 2.857 | Binder (A-2) | 26.25 | Binder (B-2) | 2.25 | Polyoxyethylene | 0.01 | Pure water | 68.558 | Polyisocy- | 0.075 |
| | dispersion (1) | | | | | | alkyl ether | | | | anate | |
| | | | | | | | | | | | compound | |
| Example 31 | Silver nanowire | 2.857 | Binder (A-1) | 26.25 | Binder (B-2) | 2.25 | Polyoxyethylene | 0.01 | Pure water | 68.623 | Alkaline | 0.010 |
| | dispersion (1) | | | | | | alkyl ether | | | | thickener | |
| Example 32 | Silver nanowire | 2.857 | Binder (A-2) | 26.25 | Binder (B-2) | 2.25 | Polyoxyethylene | 0.01 | Pure water | 68.623 | Urethane | 0.010 |
| | dispersion (1) | | | | | | alkyl ether | | | | thickener | |
| Example 33 | Silver nanowire | 2.857 | Binder (A-5) | 26.25 | Binder (B-2) | 2.25 | Polyoxyethylene | 0.005/ | Pure | 18.633/ | — | |
| | dispersion (1) | | | | | | alkyl ether/ | 0.005 | water/ | 50 | | |
| | | | | | | | alkylimidazoline | | ethanol | | | |
| Example 34 | Silver nanowire | 2.857 | Binder (A-5) | 26.25 | Binder (B-2) | 2.25 | Polyoxyethylene | 0.005/ | Pure | 18.533/ | Photoiniti- | 0.01/ |
| | dispersion (1) | | | | | | alkyl ether/ | 0.005 | water/ | 50 | ator/poly- | 0.09 |
| | | | | | | | alkylimidazoline | | ethanol | | merizable | |
| | | | | | | | | | | | macromer | |

The agents shown in Tables 2 to 4 are as follows;

Polyoxyethylene alkyl ether: product of Nippon Nyukazai Co., Ltd., product name: Newcall 2308,

Polyoxyethylene polycyclic phenyl ether: product of Nippon Nyukazai Co., Ltd., product name: Newcall 714,

Alkylimidazoline: product of Kao Corporation, product name: Homogenol L-95,

Silane coupling agent: 3-glycidoxypropyl trimethoxysilane, product of Shin-Etsu Chemical Co., Ltd., product name: KBM-403,

Polyisocyanate compound: product of Asahi Kasei Chemicals Corporation, product name: Duranate WB40-100,

Alkaline thickener: product of DIC Corporation, product name: Voncoat HV-E,

Urethane thickener: product of ADEKA Corporation, product name: Adekanol UH-540,

Photoinitiator: 1-[4-(2-hydroxyethoxy)-phenyl]-2-hydroxy-2-methyl-1-propan-1-one, product of BASF Japan Ltd., product name: Irgacure 2959, and

Polymerizable macromer: polymerizable urethane acrylate resin, product of Shin-Nakamura Chemical Co., Ltd., product name: UA7200.

TABLE 5

| | Concentration of each component relative to the total amount of composition | | | | | | | |
|---|---|---|---|---|---|---|---|---|
| | (% by mass) | | | | | Mass ratio of each component | | |
| | Silver | Total of binder | | | | Total of binder resins/ | Surfactant/ | Binder (A)/ |
| | nanowire | resins | Binder (A) | Binder (B) | Surfactant | silver nanowire | silver nanowire | Binder (B) |
| Example 1 | 0.5 | 0.750 | 0.5250 | 0.2250 | 0.0100 | 150/100 | 2/100 | 70/30 |
| Example 2 | 0.5 | 0.750 | 0.5250 | 0.2250 | 0.0100 | 150/100 | 2/100 | 70/30 |
| Example 3 | 0.5 | 0.750 | 0.5250 | 0.2250 | 0.0100 | 150/100 | 2/100 | 70/30 |
| Example 4 | 0.5 | 0.750 | 0.5250 | 0.2250 | 0.0100 | 150/100 | 2/100 | 70/30 |
| Example 5 | 0.5 | 0.750 | 0.5250 | 0.2250 | 0.0100 | 150/100 | 2/100 | 70/30 |
| Example 6 | 0.5 | 0.750 | 0.5250 | 0.2250 | 0.0100 | 150/100 | 2/100 | 70/30 |
| Example 7 | 0.5 | 0.750 | 0.5250 | 0.2250 | 0.0100 | 150/100 | 2/100 | 70/30 |
| Example 8 | 0.5 | 0.750 | 0.5250 | 0.2250 | 0.0100 | 150/100 | 2/100 | 70/30 |
| Example 9 | 0.5 | 0.750 | 0.5250 | 0.2250 | 0.0100 | 150/100 | 2/100 | 70/30 |
| Example 10 | 0.5 | 0.750 | 0.2625 | 0.4875 | 0.0002 | 150/100 | 0.04/100 | 35/65 |
| Example 11 | 0.5 | 0.750 | 0.2625 | 0.4875 | 0.0600 | 150/100 | 12/100 | 35/65 |
| Example 12 | 0.5 | 2.100 | 0.7350 | 1.3650 | 0.0100 | 420/100 | 2/100 | 35/65 |
| Example 13 | 0.5 | 0.750 | 0.5250 | 0.2250 | 0.0002 | 150/100 | 0.04/100 | 70/30 |
| Example 14 | 0.5 | 0.750 | 0.5250 | 0.2250 | 0.0600 | 150/100 | 12/100 | 70/30 |
| Example 15 | 0.5 | 2.100 | 1.4700 | 0.6300 | 0.0100 | 420/100 | 2/100 | 70/30 |

TABLE 6

| | Concentration of each component relative to the total amount of composition | | | | | | | |
|---|---|---|---|---|---|---|---|---|
| | (% by mass) | | | | | Mass ratio of each component | | |
| | Silver | Total of binder | | | | Total of binder resins/ | Surfactant/ | Binder (A)/ |
| | nanowire | resins | Binder (A) | Binder (B) | Surfactant | silver nanowire | silver nanowire | Binder (B) |
| Example 16 | 2.5 | 0.200 | 0.1400 | 0.0600 | 0.0500 | 8/100 | 2/100 | 70/30 |
| Example 17 | 10.5 | 1.680 | 1.1760 | 0.5040 | 0.2100 | 16/100 | 2/100 | 70/30 |
| Example 18 | 0.5 | 0.750 | 0.5250 | 0.2250 | 0.0004 | 150/100 | 0.08/100 | 70/30 |
| Example 19 | 0.5 | 0.750 | 0.5250 | 0.2250 | 0.0400 | 150/100 | 8/100 | 70/30 |
| Example 20 | 0.5 | 1.875 | 1.3125 | 0.5625 | 0.0100 | 375/100 | 2/100 | 70/30 |
| Example 21 | 2.5 | 0.300 | 0.2100 | 0.0900 | 0.0500 | 12/100 | 2/100 | 70/30 |
| Example 22 | 8.0 | 1.280 | 0.8960 | 0.3840 | 0.1600 | 16/100 | 2/100 | 70/30 |
| Example 23 | 0.5 | 0.750 | 0.6000 | 0.1500 | 0.0100 | 150/100 | 2/100 | 80/20 |
| Example 24 | 0.5 | 0.750 | 0.1500 | 0.6000 | 0.0100 | 150/100 | 2/100 | 20/80 |
| Example 25 | 0.5 | 0.750 | 0.5250 | 0.2250 | 0.0100 | 150/100 | 2/100 | 70/30 |
| Example 26 | 0.5 | 0.750 | 0.2250 | 0.5250 | 0.0100 | 150/100 | 2/100 | 30/70 |
| Example 27 | 0.5 | 0.750 | 0.3750 | 0.3750 | 0.0100 | 150/100 | 2/100 | 50/50 |
| Example 28 | 0.5 | 0.750 | 0.3750 | 0.3750 | 0.0100 | 150/100 | 2/100 | 50/50 |
| Example 35 | 0.5 | 0.750 | 0.5250 | 0.2250 | 0.0100 | 150/100 | 2/100 | 70/30 |
| Comparative | 0.5 | 0.750 | 0.5250 | 0.2250 | 0.0100 | 150/100 | 2/100 | 70/30 |
| Example 1 | | | | | | | | |
| Comparative | 0.5 | 0.750 | 0.5250 | 0.2250 | 0.0100 | 150/100 | 2/100 | 70/30 |
| Example 2 | | | | | | | | |
| Comparative | 0.5 | 0.750 | 0.5250 | 0.2250 | 0.0100 | 150/100 | 2/100 | 70/30 |
| Example 3 | | | | | | | | |
| Comparative | 0.5 | 0.750 | 0.7500 | — | 0.0100 | 150/100 | 2/100 | 100/0 |
| Example 4 | | | | | | | | |
| Comparative | 0.5 | 0.750 | 0.5250 | 0.2250 | — | 150/100 | 0/100 | 70/30 |
| Example 5 | | | | | | | | |
| Comparative | 0.5 | 0.750 | — | 0.7500 | 0.0100 | 150/100 | 2/100 | 0/100 |
| Example 6 | | | | | | | | |

TABLE 7

| | Concentration of each component relative to the total amount of composition | | | | | | | |
|---|---|---|---|---|---|---|---|---|
| | (% by mass) | | | | | Mass ratio of each component | | |
| | Silver | Total of binder | | | | Total of binder resins/ | Surfactant/ | Binder (A)/ |
| | nanowire | resins | Binder (A) | Binder (B) | Surfactant | silver nanowire | silver nanowire | Binder (B) |
| Example 29 | 0.5 | 0.750 | 0.5250 | 0.2250 | 0.0100 | 150/100 | 2/100 | 70/30 |
| Example 30 | 0.5 | 0.750 | 0.5250 | 0.2250 | 0.0100 | 150/100 | 2/100 | 70/30 |
| Example 31 | 0.5 | 0.750 | 0.5250 | 0.2250 | 0.0100 | 150/100 | 2/100 | 70/30 |
| Example 32 | 0.5 | 0.750 | 0.5250 | 0.2250 | 0.0100 | 150/100 | 2/100 | 70/30 |
| Example 33 | 0.5 | 0.750 | 0.5250 | 0.2250 | 0.0100 | 150/100 | 2/100 | 70/30 |
| Example 34 | 0.5 | 0.750 | 0.5250 | 0.2250 | 0.0100 | 150/100 | 2/100 | 70/30 |

TABLE 8

| | | | Result of evaluation of film | | | | | | | |
|---|---|---|---|---|---|---|---|---|---|---|
| | Result of evaluation of | | Average | | Variation in | | | | | |
| | composition | | surface electric | Uniformity | total light | Variation | Abrasion | Water | Alcohol | |
| | Preservation | Coating | resistance | of | transmittance | in haze | resis- | resis- | resis- | Adhesiveness |
| | stability | suitability | (Ω/□) | resistance | (%) | (%) | tance | tance | tance | to substrate |
| Example 1 | B/C | B | 200 | 0.50 | −3.2 | 2.28 | B | C | C | C |
| Example 2 | B/C | B | 215 | 0.48 | −3.0 | 2.38 | B | C | C | C |
| Example 3 | B/C | B | 190 | 0.52 | −4.2 | 2.75 | B | C | C | C |
| Example 4 | B/C | B | 240 | 0.52 | −2.8 | 2.38 | B | C | C | C |
| Example 5 | B/C | B | 225 | 0.55 | −3.3 | 2.28 | B | C | C | C |
| Example 6 | B/C | B | 210 | 0.46 | −3.0 | 2.18 | B | B | B | B |
| Example 7 | B | B | 160 | 0.30 | −2.3 | 1.38 | B | B | B | B |
| Example 8 | B | B | 165 | 0.31 | −2.0 | 1.28 | B | B | B | B |
| Example 9 | B | B | 155 | 0.28 | −2.4 | 1.18 | B | B | B | B |
| Example 10 | B/C | B | 195 | 0.55 | −2.8 | 1.80 | B | B | B | B |
| Example 11 | B | B | 150 | 0.29 | −1.9 | 1.28 | B | C | C | C |
| Example 12 | B | B | 250 | 0.45 | −2.0 | 1.38 | B | B | B | B |
| Example 13 | B/C | B | 142 | 0.40 | −1.8 | 1.32 | A | B | B | A |
| Example 14 | B | B | 135 | 0.21 | −1.3 | 1.01 | A | C | C | B |
| Example 15 | B | B | 200 | 0.32 | −1.4 | 1.02 | A | B | B | A |

TABLE 9

| | | | Result of evaluation of film | | | | | | | |
|---|---|---|---|---|---|---|---|---|---|---|
| | Result of evaluation of | | Average | | Variation in | | | | | |
| | composition | | surface electric | Uniformity | total light | Variation | Abrasion | Water | Alcohol | |
| | Preservation | Coating | resistance | of | transmittance | in haze | resis- | resis- | resis- | Adhesiveness |
| | stability | suitability | (Ω/□) | resistance | (%) | (%) | tance | tance | tance | to substrate |
| Example 16 | B | B | 135 | 0.20 | −1.3 | 0.97 | B | B | B | B |
| Example 17 | B/C | B | 120 | 0.21 | −1.4 | 1.00 | A | B | B | A |
| Example 18 | B | B | 108 | 0.15 | −1.2 | 0.80 | A | B | B | A |
| Example 19 | B | B | 104 | 0.14 | −1.1 | 0.88 | A | B | B | A |
| Example 20 | B | B | 120 | 0.15 | −1.1 | 0.82 | A | B | B | A |
| Example 21 | B | B | 105 | 0.13 | −1.1 | 0.78 | A | B | B | A |
| Example 22 | B | B | 110 | 0.14 | −1.1 | 0.83 | A | B | B | A |
| Example 23 | B | B | 105 | 0.15 | −1.1 | 0.80 | B | B | B | B |
| Example 24 | B | B | 135 | 0.31 | −1.0 | 0.78 | A | B | B | A |
| Example 25 | B | B | 90 | 0.12 | −0.8 | 0.56 | A | B | B | A |
| Example 26 | B | B | 95 | 0.15 | −0.9 | 0.58 | A | B | B | A |
| Example 27 | B | B | 88 | 0.11 | −0.8 | 0.53 | A | B | B | A |
| Example 28 | B | A | 85 | 0.10 | −0.7 | 0.50 | A | A | A | A |
| Example 35 | B/C | B | 320 | 0.65 | −6.5 | 2.82 | B | B | B | B |
| Comparative | C | C | 1200 | 0.80 | −14.5 | 4.68 | B | C | C | C |
| Example 1 | | | | | | | | | | |
| Comparative | C | C | 1150 | 0.78 | −11.5 | 3.98 | B | C | C | C |
| Example 2 | | | | | | | | | | |
| Comparative | C | C | 1000 | 1.00 | −9.5 | 4.38 | B | C | C | C |
| Example 3 | | | | | | | | | | |
| Comparative | B/C | B | 350 | 0.65 | −4.5 | 4.18 | D | D | D | D |
| Example 4 | | | | | | | | | | |
| Comparative | D | B | 5000 | 5.00 | −14.5 | 7.18 | B | C | C | C |
| Example 5 | | | | | | | | | | |
| Comparative | D | C | 100000 | 8.00 | −18.5 | 9.50 | C | D | D | C |
| Example 6 | | | | | | | | | | |

TABLE 10

| | | | Result of evaluation of film | | | | | | | |
|---|---|---|---|---|---|---|---|---|---|---|
| | Result of evaluation of | | Average | | Variation in | | | | | |
| | composition | | surface electric | Uniformity | total light | Variation | Abrasion | Water | Alcohol | |
| | Preservation | Coating | resistance | of | transmittance | in haze | resis- | resis- | resis- | Adhesiveness |
| | stability | suitability | (Ω/□) | resistance | (%) | (%) | tance | tance | tance | to substrate |
| Example 29 | B | B | 165 | 0.30 | −2.7 | 1.45 | A | A | A | A |
| Example 30 | B | B | 170 | 0.30 | −2.5 | 1.52 | A | A | A | A |
| Example 31 | A | B | 162 | 0.31 | −2.2 | 1.28 | B | B | B | B |
| Example 32 | A | B | 170 | 0.30 | −2.1 | 1.18 | B | B | B | B |
| Example 33 | B/C | B | 160 | 0.35 | −2.4 | 1.48 | B | C | C | C |
| Example 34 | B/C | B | 168 | 0.32 | −2.3 | 1.28 | A | A | A | A |

In Comparative Examples 1 to 3 containing undesirable binders, such as poly(vinyl alcohol), as the binder component (A), the silver nanowire-containing compositions had poor preservation stability and coating suitability and the coating film had low conductivity and transparency and high turbidity, compared to Example 1.

In Comparative Example 4 not containing any binder component (B), the coating film had low conductivity and transparency and high turbidity and had low abrasion resistance, water resistance, alcohol resistance, and adhesiveness to a substrate, compared to Examples 1 to 3.

In Comparative Example 5 not containing any surfactant, the silver nanowire-containing composition had low preservation stability and the coating film had low conductivity and transparency and high turbidity, compared to Example 1.

In Comparative Example 6 not containing any binder component (A), the silver nanowire-containing composition had poor preservation stability and coating suitability and the coating film had low conductivity and transparency and high turbidity and had low abrasion resistance, water resistance, and alcohol resistance, compared to Example 1.

In Example 6 containing an aqueous polyester resin as the binder component (B), the coating film had high water resistance, alcohol resistance, and adhesiveness to a substrate, compared to Examples 1 to 5.

In Examples 7 to 9 containing more preferred binder components (A), such as hydroxypropyl guar gum, the silver nanowire-containing compositions had high preservation stability and the coating film had high conductivity and transparency and low turbidity, compared to Example 6.

In Examples 13 to 15 containing binder components (A) prepared by modifying the binders used in Examples 10 to 12, respectively, with (meth)acrylate esters, the coating film had high conductivity and transparency, low turbidity, and high abrasion resistance and adhesiveness to a substrate, compared to Examples 10 to 12 in which the unmodified binders were used.

In Example 18 containing the surfactant at an amount suitable for the silver nanowires, the silver nanowire-containing composition had high preservation stability and the coating film had high conductivity and transparency and low turbidity, compared to Example 13 in which the amount of the surfactant was outside the preferable range.

In Example 19 containing the surfactant at an amount suitable for the silver nanowires, the coating film had high water resistance, alcohol resistance, and adhesiveness to a substrate, compared to Example 14 in which the amount of the surfactant was outside the preferable range.

In Example 20 containing the binder at an amount suitable for the silver nanowires, the coating film had high conductivity, compared to Example 15 in which the amount of the binder was outside the preferable range.

In Example 21 containing the binder at an amount suitable for the silver nanowires, the coating film had high abrasion resistance and adhesiveness to a substrate, compared to Example 16 in which the amount of the binder was outside the preferable range.

In Example 22 containing the silver nanowires at a ratio suitable for the composition, the silver nanowire-containing composition had high preservation stability, compared to Example 17 in which the content of the silver nanowires was higher than the preferable ratio.

In Example 25 containing the binder components (A) and (B) at a mass ratio within a preferable range, the coating film had high abrasion resistance and adhesiveness to a substrate, compared to Example 23 in which the mass ratio of the binder components was outside the preferable range.

In Example 26 containing the binder components (A) and (B) at a mass ratio within a preferable range, the coating film had high conductivity, compared to Example 24 in which the mass ratio of the binder components was outside the preferable range.

In Example 28 containing a binder component (B) prepared by modifying the aqueous polyester resin used in Example 27 with a (meth)acrylate ester, the silver nanowire-containing composition had high coating suitability and the coating film had high water resistance and alcohol resistance, compared to Example 27 in which the unmodified resin was used.

In Example 29 containing a silane coupling agent, the coating film had high abrasion resistance, water resistance, alcohol resistance, and adhesiveness to a substrate, compared to Example 7.

In Example 30 containing a polyisocyanate compound, the coating film had high abrasion resistance, water resistance, alcohol resistance, and adhesiveness to a substrate, compared to Example 8.

In Example 31 containing an alkaline thickener, the composition had high preservation stability, compared to Example 7.

In Example 32 containing a urethane thickener, the composition had high preservation stability, compared to Example 8.

In Example 34 containing a photoinitiator and a polymerizable macromonomer, the coating film had high abrasion resistance, water resistance, alcohol resistance, and adhesiveness to a substrate, compared to Example 33.

In Example 7 containing silver nanowires produced by a method involving a step of reacting a silver compound in a polyol at 100° C. to 180° C. in the presence of a wire integration regulator being an N-substituted acrylamide-containing polymer, the composition had high preservation stability and the coating film had high conductivity and transparency and low turbidity, compared to Example 35.

### INDUSTRIAL APPLICABILITY

The metal nanowire-containing composition of the present invention has high preservation stability and coating suitability and can form a coating film having satisfactory transparency, turbidity, and conductivity and also having high water resistance, abrasion resistance, alcohol resistance, and adhesiveness to a substrate. Accordingly, the composition can be widely used, for example, for forming transparent conductive films of various types of devices, such as electrode components of liquid crystal displays, electrode components of plasma displays, electrode components of organic electroluminescent displays, electrode components of electronic paper, electrode components of touch panels, electrode components of thin-film amorphous Si solar cells, electrode components of dye-sensitized solar cells, electromagnetic shielding components, and antistatic components.

1. A metal nanowire-containing composition, comprising:
a metal nanowire;
a binder;
a surfactant; and
a solvent,
wherein the binder comprises binder components (A) and (B), and
wherein the binder component (A) is a polysaccharide, and
the binder component (B) is at least one selected from the group consisting of an aqueous polyester resin, an aqueous polyurethane resin, and an aqueous acrylic resin.

2. The metal nanowire-containing composition according to claim 1,
wherein the binder component (B) is the aqueous polyester resin.

3. The metal nanowire-containing composition according to claim 1,
wherein the binder component (A) is at least one selected from the group consisting of hydroxypropyl guar gum and a derivative thereof, hydroxypropyl methyl cellulose and a derivative thereof, and methyl cellulose and a derivative thereof.

4. The metal nanowire-containing composition according to claim 1,
wherein the binder component (A) is a polysaccharide derivative prepared by graft polymerization of a (meth)acrylate ester.

5. The metal nanowire-containing composition according to claim 1,
wherein the metal nanowire is present in an amount of at most 10 parts by mass relative to 100 parts by mass of the total amount of the metal nanowire-containing composition;
the binder is present in an amount of from 10 to 400 parts by mass relative to 100 parts by mass of the metal nanowire; and
the surfactant is present in an amount of from 0.05 to 10 parts by mass relative to 100 parts by mass of the metal nanowire.

6. The metal nanowire-containing composition according to claim 1,
wherein the mass ratio of the binder component (A) to the binder component (B) is from 25:75 to 75:25.

7. The metal nanowire-containing composition according to claim 1,
wherein the binder component (B) is an aqueous polyester resin prepared by graft polymerization of a (meth)acrylate ester.

8. The metal nanowire-containing composition according to claim 1, further comprising:
a silane coupling agent.

9. The metal nanowire-containing composition according to claim 1, further comprising:
a polyisocyanate compound.

10. The metal nanowire-containing composition according to claim 1, further comprising:
at least one of a photoinitiator and a thermal polymerization initiator and
at least one of a polymerizable monomer and a macromonomer.

11. The metal nanowire-containing composition according to claim 1,
wherein the metal nanowire-containing composition is for a transparent conductive film.

12. The metal nanowire-containing composition according to claim 1, further comprising:
an alkaline thickener or a urethane thickener.

13. The metal nanowire-containing composition according to claim 1,
wherein the metal nanowire is a silver nanowire.

14. The metal nanowire-containing composition according to claim 13,
wherein the silver nanowire is produced by a method comprising:
reacting a silver compound in a polyol at from 25° C. to 180° C. in the presence of an N-substituted acrylamide-containing polymer.

15. (canceled)

16. A transparent conductor, comprising:
a substrates and
the metal nanowire-containing film according to claim 1 disposed on the substrate.

17. The metal nanowire-containing composition according to claim 2,
wherein the binder component (A) is a polysaccharide derivative prepared by graft polymerization of a (meth)acrylate ester.

18. The metal nanowire-containing composition according to claim 17,
wherein the metal nanowire is present in an amount of at most 10 parts by mass relative to 100 parts by mass of the total amount of the metal nanowire-containing composition;
the binder is present in an amount of from 10 to 400 parts by mass relative to 100 parts by mass of the metal nanowire; and
the surfactant is present in an amount of from 0.05 to 10 parts by mass relative to 100 parts by mass of the metal nanowire.

19. The metal nanowire-containing composition according to claim 17,
wherein the mass ratio of the binder component (A) to the binder component (B) is from 25:75 to 75:25.

20. The metal nanowire-containing composition according to claim 17,
wherein the metal nanowire is a silver nanowire.

21. The metal nanowire-containing composition according to claim 20,
wherein the silver nanowire is produced by a method comprising:
reacting a silver compound in a polyol at from 25° C. to 180° C. in the presence of an N-substituted acrylamide-containing polymer.
